(19) United States
(12) Patent Application Publication
(10) Pub. No.: US 2018/0058320 A1
(43) Pub. Date: Mar. 1, 2018

(54) HYBRID GAS TURBINE POWER GENERATION SYSTEM

(71) Applicant: ENERGY TECHNOLOGIES INSTITUTE LLP, Leicestershire (GB)

(72) Inventor: James MACNAGHTEN, Hampshire (GB)

(73) Assignee: Energy Technologies Institute LLP, Leicestershire (GB)

(21) Appl. No.: 15/553,121

(22) PCT Filed: Mar. 2, 2016
(86) PCT No.: PCT/GB2016/050547

§ 371 Date: Aug. 23, 2017

(30) Foreign Application Priority Data
Mar. 6, 2015 (GB) 1503848.2
Dec. 23, 2015 (GB) 1522742.4

(51) Int. Cl. F02C 6/16; F02C 6/10; F02C 9/28

(52) U.S. Cl. CPC F02C 6/16; F02C 6/10; F05D 2240/35; F05D 2220/32; F02C 9/28

(57) ABSTRACT

Some embodiments are directed to a method of modulating power output of a hybrid gas turbine power plant, including a conventional (GT) gas turbine, via a fluid connection(s) allowing air injection or extraction, further including a compressed air energy storage system (CAES). Power is increased or decreased by selectively reconfiguring the GT compressor to reduce or increase its mass flow rate whilst simultaneously selectively adjusting how much air to transfer as a compensatory mass flow between the CAES and GT systems, via the fluid connection(s), temporarily minimizing any change in mass flow rate and hence operating conditions in the combustor, thereby providing improved frequency response mode wherein power is modulated to meet grid fluctuations in under ten seconds. Use of an adiabatic CAES system with a direct TES can return heat immediately and damp pressure fluctuations, and rapid bleed rates may be achieved temporarily by venting to atmosphere.

### CROSS REFERENCE TO RELATED APPLICATIONS

This application is a national phase filing under 35 C.F.R. §371 of and claims priority to PCT Patent Application No. PCT/GB2016/050547, filed on Mar. 2, 2016, which claims the priority benefit under 35 U.S.C. §119 of British Patent Application Nos. 1503848.2 and 1522742.4, filed on Mar. 6, 2015 and Dec. 23, 2015, respectively, the contents of each of which are hereby incorporated in their entireties by reference.

### BACKGROUND

Some embodiments relate to a hybrid combustion turbine power generation system, and a method of modulating the power output of the same. In particular, some embodiments are concerned with a hybrid system in which a conventional combustion turbine is integrated with a compressed air energy storage (CAES) system.

CAES systems utilizing thermal energy storage (TES) apparatus to store heat have been known since the 1980's. Adiabatic compressed air energy storage (ACAES) systems store the heat of compression of the compressed air in thermal stores for subsequent return to the air as it leaves a compressed air store before undergoing expansion. The TES apparatus may contain a thermal storage medium through which the compressed air passes, releasing heat to the storage medium, thereby heating the store and cooling the air. The thermal storage medium may be in the form of a porous storage mass, which may be a packed bed of solid particles through which the air passes exchanging thermal energy directly, or, it may comprise a solid matrix or monolith provided with channels or interconnecting pores extending therethrough, or, the fluid may pass through a network of heat exchange pipes that separate it from the storage mass, such as a packed bed of particles (e.g. rocks).

Alternatively, some of the compressed air may pass through a heat exchanger that is coupled to a separate thermal store, such that heat is transferred indirectly to the latter via a heat transfer fluid, in which case the thermal store need not be pressurised and could include a thermal storage medium such as a molten salt or high temperature oil. However, thermal energy stores based on indirect thermal transfer (indirect TES) have much lower efficiencies than ones that store heat directly (direct TES) as mentioned above. In addition the heat exchanger of an indirect TES normally takes a finite amount of time to reach equilibrium conditions and hence, if left inactive, needs warming to temperature before use. Furthermore, for large heat transfer rates this is likely to be quite an expensive heat exchanger.

Air injected power augmentation of combustion turbines is used to increase the power output of a gas turbine up to its normal maximum allowable power where, for example, the power has dropped due to high altitude or high ambient temperatures reducing the density of inlet air. FIG. 1 shows the variation of power output of a gas turbine with ambient temperature. Externally compressed, heated air is injected into the gas turbine upstream of the combustor in order to improve the power output.

U.S. Pat. No. 5,934,063 to Nakhamkin proposes a hybrid combustion turbine power generation system (CTPGS) in which a gas turbine is integrated with an ACAES system and pressurised air from the air storage is injected at the combustor to augment the air flow through the gas turbine and hence increase the power output when it would otherwise be below its maximum allowable level. In U.S. Pat. No. 5,934,063, the returning stored air is heated with waste heat from the turbine or from a downstream steam turbine. WO2013/116185 relates to another hybrid CTPGS which instead proposes the use of various heat exchanger stages during the storage mode to store the heat of compression for subsequent return.

There have also been proposals to integrate a combustion turbine (GT) system with an ACAES system, whereby the compressor may be selectively coupled and decoupled from the turbine to allow their independent operation such that the gas turbine can operate in multiple modes; selector valve arrangements may be disposed within the combustion turbine flow path to divert the airflow into and out of the combustion turbine in these multiple modes. However, to date no commercial systems exist due to the cost and complexity of developing such a decouplable gas turbine system.

Integration of an ACAES into a gas turbine system can allow such a hybrid system to turn up or turndown its power output in response to a changing grid requirement. However, where the hybrid system is based on a gas turbine of a conventional arrangement, in which the compressor and turbine are always coupled together for simultaneous operation and air flow is always passing successively downstream through the compressor, combustor and turbine, then any power modulation is limited by the inherent limits and characteristics of the gas turbine. Prior art has focussed upon extending the respective limits of turn-up and turndown and upon improving the efficiency of such modes of operation. However, there is also a need to improve the speed of response.

Current grid requirements require a power plant to be able to increase output by 10% within ten seconds. This is used by the TSO (Transmission System Operator) to supply additional rapid power increases to the network in the case that there is a large loss of generation—for example a power stations trips off or an interconnector is lost. The TSO normally requires or pays for sufficient capacity that it can manage any normal events.

When there is the loss of a large generator, the system frequency immediately starts to drop. The rate at which the frequency drops is a function of how much generation has been lost, how much generation remains, and how much rotating inertia there is on the system. Large thermal power plants have grid synchronised machinery that is directly coupled to the grid. This spinning plant has inertia and it slows the rate at which the frequency falls.

Traditionally on most large grids ten second response times were adequate to deal with unexpected events.

However, wind turbines and solar photo-voltaic (PV) are being adopted on a large scale and they have a double impact on the system. They provide no inertia to the system and they have no marginal cost of production. Consequently when there is a large amount of renewables generating the thermal power plant switches off. This means that the amount of inertia on the system is reduced and the rate of change of frequency increases. There is a further potential issue in that the size of generating units is getting larger. For example, proposed new nuclear power stations are approximately 1600 MW per unit and this means that the grid operator needs to allow for a larger loss of generation and a much faster changing frequency. Consequently, it is desirable that power plants can increase power in a matter of seconds, rather than ten seconds, preferably over a larger range than a 10% increase. This requirement for rapid power is normally only required for short periods of time as other generating assets can normally be brought on line over periods of minutes to replace the lost generation.

Methods of increasing or decreasing power output involve altering the mass flow rate within the gas turbine. For example, power output may be increased by injecting more air from storage but there are limitations on the rate at which air can be injected. For example, thermal stresses need to be managed: as the pressure ratio changes the temperature in the compressor and turbine sections both change and this can lead to thermal stresses that are potentially damaging to the gas turbine and can lead to increased maintenance and likelihood of unpredicted enforced outages. Another concern is combustor stability. DLN combustors normally operate on a very lean mixture and it is possible to ‘blow’ them out if the air fuel ratio is changed to quickly. Accordingly, to avoid these issues, it is usually necessary to limit the rate of change of the mass flow rate within the combustion turbine so that the air fuel ratio within the combustor does not alter too quickly.

### SUMMARY

Some embodiments are directed towards providing an improved hybrid combustion turbine power generation system and, in particular, one in which the system can modulate its power output within a very short period of time (e.g. within a few seconds).

In accordance with a first aspect of the present invention, there is provided a method of modulating the power output of a hybrid combustion turbine power generation system (CTPGS) comprising:

a combustion turbine (GT) system comprising a compressor, a combustor and a turbine fluidly connected downstream of each other; and,

a compressed air energy storage (CAES) system integrated with the GT system via one or more fluid connections to the GT system so as to allow air to be extracted from, or injected into, the GT system;

wherein the CAES system comprises an airflow passageway network and associated valve structure leading from the one or more fluid connections to a compressed air store;

the method comprising modulating the power output whilst air is passing respectively downstream through the compressor, combustor and turbine by increasing or decreasing the power output by, respectively, selectively reducing or increasing the mass flow rate of the air through the compressor by altering its configuration, and simultaneously selectively adjusting how much air to transfer as a compensatory mass flow between the CAES system and the GT system via the one or more fluid connections, in order partially or fully to compensate for the reduction or increase in mass flow rate through the compressor, thereby minimising or preventing any change in mass flow rate through the combustor and turbine at least for a selected time period.

A reduction or increase in the mass flow rate through the compressor will lead to a commensurate reduction or increase in the power it draws, and hence, to a corresponding increase or reduction in (overall) power output, respectively. By injecting and/or bleeding some, or more, air as a compensatory mass flow at a selected mass flow rate (for example, at a mass flow rate less than or roughly equal to the change in the compressor mass flow rate) from or to the integrated CAES system, by means of fluid connections suitably located in the GT, it is possible to minimise or prevent any change in mass flow rate through the combustor and turbine, and hence, any change in the pressure and temperature conditions there, for a selected time period. By proactively partially or fully balancing mass flow rate in this way, the power can be changed at a faster rate than usual methods involving a more significant change in the mass flow rate through the GT with the associated (time sensitive) change in GT operating conditions.

Currently, power plants may be called upon to operate in a “Frequency Response” mode (FR Mode) i.e. an initial power generation mode from which they can increase output by 10% within ten seconds to meet grid fluctuations. The present invention may allow a power plant to offer an “Improved Frequency Response Mode” or IFR Mode, i.e. an initial power generation mode from which they can modulate power to the second power output in under 10 seconds, for example, within a response time of 7 seconds or less, or preferably, even 5 seconds or less, or even 3 seconds or less. The hybrid system may be configured to operate in both an IFR mode and a less time critical FR mode.

In a preferred embodiment, the CAES system is integrated with the GT system such that it charges and discharges via the GT system, air being both extracted from it, and injected into it, via the one or more fluid connections. While the CAES system will usually both send air to, and receive and store compressed air from the GT system, other hybrid systems in which, for example, the CAES system is additionally charged by, or only charged by, separate power machinery, are not excluded.

For improved efficiency, the compressed air energy storage system will usually comprise an adiabatic compressed air energy storage system (ACAES) that stores and returns thermal energy (i.e. heat of compression) to the compressed air. Thus, the airflow passageway network may comprise a first thermal energy store (TES) that removes and returns thermal energy to the compressed air upon charging and discharging the air store, disposed between the latter and the one or more fluid connections.

In a preferred embodiment, the first TES is a direct TES. A store based on direct thermal transfer contains a thermal storage medium through which the compressed air passes, releasing heat to the storage medium, thereby heating the store and cooling the air. It can return the heat stored in it to a gas flow efficiently and without delay. The thermal storage medium may be in the form of a porous storage mass, which may be a packed bed of solid particles through which the air passes exchanging thermal energy directly, or, it may comprise a solid matrix or monolith provided with channels or interconnecting pores extending therethrough, or, the fluid may pass through a network of heat exchange pipes that separate it from the storage mass, such as a packed bed of particles (e.g. rocks).

A direct TES may also have a significant volume of air at all times which is advantageous because it can provide some damping to pressure fluctuations within the TES when valves open and close rapidly. In addition, if further damping is required it may be advantageous to provide one or more additional compressed air buffers (volumes of air at the same pressure as the TES and linked by open fluid connections) that are directly linked to the TES. These will normally be connected to the ambient temperature side of the TES. The addition of these further volumes of compressed air will further reduce any pressure fluctuations within the TES from the rapid opening and closing of valves (either into or out of the TES). One or more buffers may provide an additional volume of free air that is at least 2× the free volume in the TES, or at least 3× the free volume, or at least 4× the free volume in the TES.

The CAES system may comprise an indirect first TES, that is, a thermal energy store based on indirect thermal transfer. This may comprise a heat exchanger that is coupled to a separate thermal store, such that heat is transferred indirectly to the latter via a heat transfer fluid, in which case the thermal store need not be pressurised and could include a thermal storage medium such as a molten salt or high temperature oil. However, such stores are less efficient that a direct TES and if left inactive need rewarming.

As discussed further below, a heater system may be provided instead of, or, in addition to, a direct or indirect TES, for example, where the heat is supplied either directly or indirectly by a fossil fuel.

In a preferred embodiment, the compensatory mass flow ensures that the rate of change of mass flow rate within the combustor and turbine does not exceed 6% per second (with respect to that flow rate) for the selected time period. However, more preferably, it is limited to changing by not more than 4% per second, or even not more than 2% per second.

In a highly preferred embodiment, the compensatory mass flow ensures that the mass flow rate through the combustor and turbine remains substantially unchanged for the selected time period. Thus, the compensatory mass flow may be selectively adjusted exactly to match the change in mass flow rate through the compressor. By balancing the change in this way, a substantially unchanged mass flow rate may be maintained within the combustor and turbine (e.g. varying by +/−2% of the previous mass flow rate there). Hence, the temperature and pressure conditions within the combustor and turbine remain broadly unchanged. As a result, the rate at which the power is modulated is not restricted by the usual considerations associated with protecting the gas turbine, such as avoiding thermal stresses or destabilising the combustor. In this way, power may be modulated within a certain range within a very fast response period.

In a preferred method, the power output is modulated from an initial power output (e.g. in an initial power generation mode) to a second power output (e.g. in a second power generation mode) within a response time of 5 seconds or less.

In one embodiment, the CAES system is operating before the power modulation in a mode in which it maintains air for injection into the one or more fluid connections at a pressure upstream thereof of at least 0.5 bar higher, or even 1 bar higher or even 5 bar higher than the gas turbine operating pressure (e.g. in combustor). Thus, when the power needs to be modulated, air (or more air) can be injected rapidly into the gas turbine by a fast responding valve operating across this pressure drop. A larger pressure drop also means that transient pressure changes on either side (particularly upstream of the valve ie between the valve and the TES) will have less impact and hence, the mass flow rate can be accurately adjusted. Preferably, the CAES system is configured so that this pressure drop may be sustained once the power modulation step has started for the selected time period, such as, for example, at least 3 seconds, or preferably, at least 5 seconds.

In one embodiment, the CAES system comprises at least one flow regulating device to regulate the mass flow rate of air being injected into, or extracted from the one or more fluid connections, optionally positioned between any TES or heater system that is present in the network, and the one or more fluid connections.

The flow regulating device may be the mechanism that maintains a constant or varying (but controlled) flow through it (this may be actively controlled to allow a constant or varying flow with a varying pressure difference across the flow regulating device). The pressure may vary upstream of the flow regulating device as referenced above, for the reasons given above. The device should selectively (e.g. preferably, finely) adjust flow rate such that the compensatory mass flow is carefully controlled. When a fast response time is required, further opening of the valve may allow rapid flow (injection) of air into the GT system. The flow regulating device will usually be operatively associated with a controller and any required sensors in the flow network (e.g. taking measurements, such as, for example, pressure and temperature) from which mass flow rate data may be derived. A simple (e.g. on/off) valve may also be provided upstream or downstream of any flow regulating device, which may allow the latter to be adjusted beforehand to a new desired setting.

A further flow regulating device will usually be required between any TES or heater system that is present in the network and the compressed air store. In addition it is likely that there will be additional valves, bypass valves or vent valves (so as to protect any power machinery from the high pressure of the air store when not operating or during start up and/or shut down.

In one embodiment, the compensatory mass flow between the CAES system and the GT system is provided via one or more fluid connections provided in ancillary passageways of the GT system containing airflow that bypasses the combustor (“bypass airflow”).

The one or more fluid connections may be any port (e.g. bleed port or injection port) or opening that allows air to be extracted from, or injected into, the GT system, including ones controlled by valves; different fluid connections may be used for bleed and injection, respectively. The connections may be so located as to allow air to be directly or indirectly extracted from, or injected into, the main airstream(s) passing down through the gas turbine. Fluid connections may also be provided in ancillary passageways in the GT system containing airflow that bypasses the combustor (“bypass airflow”), including ducting that ducts cooling air (from compressor) to different parts of the gas turbine, since adjusting air in such ducts can be used indirectly to provide the afore-mentioned balancing of the mass flow in the combustor and turbine.

In one embodiment, the configuration of the compressor is altered by altering the angle of variable inlet guide vanes. The GT compressor may be provided with any of the following which may be used alone or in combination to vary the mass flow rate through it: variable inlet guide vanes (IGV's), variable exit guide vanes (EGV's), or other variable compressor geometry or a compressor inlet restrictor or other inlet equipment associated with the compressor (e.g. filter).

The change in compressor configuration (e.g. setting) may involve a change in compressor geometry and will preferably only change the mass flow rate of air drawn in (as opposed for example to other characteristics of the intake air e.g. such as its temperature). For large industrial gas turbines the normal control of the compressor is the variable inlet guide vanes. These can generally vary the mass flow through the compressor from 70% (fully closed) to 100% (fully open). There may also be some additional blow off valves (vents) that are used when starting the gas turbine.

Thus, the mass flow rate of the air through the compressor may be reduced by making the guide vanes less open, or increased by making the guide vanes more open. In an IFR mode, the guide vane setting should obviously be selected such that it has the capacity to change the vane setting by the amount required for the next power generation mode. It will usually be set (in a partially open position) such that the vanes can open further and can close further, allowing modulation in both directions, but operation in an IFR mode where the inlet guide vanes are fully open is not excluded when it is desirable to have only the ability to increase power rapidly while operating at 100% power output. This is normally the most efficient mode of power generation and the ability to increase power rapidly is normally more valuable than the ability to decrease it, since it is more common to lose a large generating asset than lose a large load (i.e. most power stations are much bigger than the customers that they serve).

In one embodiment, the CAES system further comprises air depressurisation apparatus in fluid communication with the one or more fluid connections for depressurising compressed air extracted from the GT system (rather than storing that air in the CAES).

Air depressurisation apparatus may allow increased power modulation as it may increase the range over which the compressor mass flow can be varied. Thus, if a gas turbine can only safely inject 50 kg/s of air (to avoid compressor surge or stall), then if injection flows are only used for power modulation then 50 kg/s is also the limit on the amount of rapid variation in the compressor mass flow. Hence, the strategic use of bleed (i.e. an extraction mode) in an initial power generation mode can increase the apparent range over and above that allowed by injection during a subsequent power modulation step. Bleed flow through air depressurisation apparatus will however involve an efficiency penalty and additional machinery cost, with larger bleed flows requiring more modification to the GT (e.g. larger ports).

The air depressurisation apparatus may comprise a hot air expander or combined combustor/turbine that extracts useful work.

Air depressurisation apparatus for depressurising extracting compressed air may comprise a hot gas expander that extracts useful work, such as a hot air expander with its own ambient air outlet, or a combined combustor/turbine optionally connected to a main HRSG (for the GT system) or its own HRSG and steam turbine. The hot air expander or turbine should normally be able to operate over the same maximum pressure ratio as the main gas turbine. Such apparatus could not respond from a cold start if it is desired to undertake a rapid power modulation, but can be used to produce useful work when the GT system is operating in a mode (e.g. an initial power generation mode) where it expects to be called upon to provide a rapid power modulation. Such a combustor/turbine could have the compressed air to the combustor pre-heated by the exhaust from the turbine, rather than its exhaust providing additional power via an HRSG.

Similarly to the GT, the system may be configured such that the mass flow rate remains unchanged in the hot air expander or combined combustor/turbine, or only varies a small amount (e.g. varying by less than +/−6%/second of the previous mass flow rate there or 4% or 2%) after a power modulation, in particular where a combustor/turbine arrangement is used. This may even be the case where the source of air (being expanded) changes after the power modulation (e.g. air bled from the GT being replaced with air from storage).

It will be realised by one skilled in the art that the hot air expander or combined combustor/turbine are directly connected to the gas turbine, which processes a much larger quantity of air. Consequently the gas turbine will have a strong influence on the rate that this can change. For example if the mass flow to the depressurisation apparatus is controlled by a choke valve then the pressure upstream will only change as the pressure in the main gas turbine changes. Consequently, this will limit the changes experienced to a similar level seen by the gas turbine. Alternatively, where there is variable flow control to the depressurisation apparatus it may be possible to vary the mass flow rate through the air depressurisation apparatus significantly without there being any significant temperature changes. (This is likely to be less challenging for a hot air expander as it operates at temperatures where variable guide vanes can function more easily.)

Alternatively, the air depressurisation apparatus may be a device that does not extract useful work, such as, for example, a venting valve/throttle valve to atmosphere (i.e. a lower cost device able to operate at a higher mass flow rate). The latter (unlike power machinery) can respond rapidly from a cold start, so does not need to be operating when it is desired to undertake a rapid power modulation, and can provide very rapid bleeding during the power modulation, by venting to atmosphere, with a pressure drop optionally in the 10 to 20 bar range. This may allow good control of the compensatory mass flow rate, as well as a significant reduction in power, more so than a connection to a hot gas expander, but this mode would obviously only be used as a transient mode, given its inefficiency.

In one embodiment, the air depressurisation apparatus is connected by its own separate respective airflow passageways to the one or more fluid connections (for operation independent of the status of the CAES system). Thus, the air depressurisation apparatus may share at least some of the airflow passageways in which air usually flows to storage, or may comprise separate respective (e.g. direct) airflow passageways to the one or more fluid connections such that they may operate independently of the operational status of the CAES system.

In one embodiment, the hybrid system comprises a controller and associated sensors to (i) alter the configuration of the compressor in order to obtain a desired modulation of the power output, and to (ii) selectively adjust how much air to transfer as a compensatory mass flow between the CAES system and the GT system.

Immediately prior to the power modulation, the GT system may be operating in an initial power generation mode where no air is transferring between the CAES system and the GT system, or air may be being injected from the CAES system into the GT system, or air may be being extracted to the CAES system from the GT system. Thus, prior to modulating the power, the CAES system may be in any of an inactive mode, a charging mode, or discharging mode. Usually, in order to meet surges of demand during peak periods, a power modulation will be needed when the hybrid system is operating at or near full (peak) load (e.g. within 15% or even within 10% or within 5% of 100% load).

For a fast response, all apparatus needed for the power modulation should be able to respond rapidly. Accordingly, apparatus should be able to respond from a cold start (e.g. a venting or pressure reducing valve), or alternatively, for apparatus that cannot do so, the initial power generation mode should be one in which the apparatus in question is already operating (e.g. hot air expander) or otherwise held in readiness (e.g. on a minimal setting). For example, where the CAES system comprises a direct first TES, which holds its heat, the CAES system may respond from an inactive status to provide stored hot compressed air from storage. If the CAES system comprises an indirect first TES, in which heat is transferred via a heat exchanger to other stores, then such an arrangement may need to be operating in the initial power generation mode so that the heat exchanger was already active and up to temperature.

In one embodiment, the compensatory mass flow is provided for a selected time period of no more than 20 seconds (or no more than 30 seconds, or even no more than 1 minute) before the GT system alters to a different power generation mode.

Where the power is modulated from an initial power output in an initial power generation mode to a second power output in a second power generation mode, that mode is likely to be used temporarily merely to provide a very rapid response i.e. as a transitional mode. Hence, the selected time period in which the compensatory mass flow is provided in that second mode may be no more than 1 minute (or no more than 30 seconds, or even no more than 20 seconds) before altering to a different power generation mode.

Further modulation of the power may then be carried out in a conventional manner in slower time (e.g. in next 5-15 seconds) with the usual associated change of downstream mass flow rate within the combustor and turbine.

However, the hybrid system may remain operating in the second power generation mode for a significant period of time (e.g. for more than 10 minutes, or more than 30 minutes), for example, if it is energy efficient.

In one embodiment, at least one further stage of power machinery is provided between the GT system and the air store, optionally between any TES or other heat removal system that is present in the network, and the air store. The at least one further stage of power machinery and a pressure reducing device (e.g. throttle valve) may be provided in alternative passageways between the GT system and the air store. Usually the further stage of power machinery will comprise an intercooled compressor disposed in a parallel passageway to the pressure reducing device which does no useful work and may comprise a throttle valve.

In one embodiment, the airflow passageway network comprises a heater system that transfers thermal energy to compressed air that is discharging from the air store.

Such a heater system (i.e. that is not returning stored heat) may be provided in the airflow passageway network instead of a first thermal energy store (TES), or, in addition to the latter. If it is provided in addition, this may be in series for example, downstream disposed between the TES and the GT fluid connections (e.g. so as to provide “top-up heat”). Alternatively, it may be provided in an alternative (e.g. parallel) passageway, for example, to provide additional heat (for additional mass flow) or to provide heat at a faster rate or to provide heat at a different temperature. A heater system may be configured such that the air returning from storage can be heated to a desired temperature having regard to the expected GT system conditions (e.g. to match them or exceed them by a selected amount). For example, a control system may selectively adjust the temperature of any newly injected flow upon a rapid power modulation (e.g. where that starts to involve an injected flow) to ensure the injected flow is less than 50° C., more usually less than 30° C., or less than 20° C. different from the current GT compressor outlet temperature, so as to minimise a significant temperature change in the combustor. A direct or indirect TES is less flexible in that it will return heat at roughly the same temperature that it was charged (inevitably slightly degraded). For this reason, where there is no additional heater system, it may be desirable to charge an ACAES hybrid system that includes a direct or indirect TES with compressed air with the GT system running at the similar operating conditions (or slightly raised with respect thereto) as the mode (i.e. “Initial Mode”) from which it offers an Improved Frequency Response, so that air returning via the TES receives heat of a suitable temperature.

Such a heater system may comprise a direct combustor that heats the air that is discharging from the air store.

While less efficient than a TES, a direct combustor (i.e. based on internal combustion within a gas flow path usually with a fossil fuel) is convenient and may respond rapidly. It will use less fuel than any heating system based on indirect combustion and exhaust gases do not require a separate exhaust device. Such a direct fired additional combustor may easily be kept in readiness to respond to a rapid power modulation requirement.

Alternatively, the heater system may comprise a heat exchanger that heats the air that is discharging from the air store. Thus, the heater system may comprise an indirectly heated heat exchanger that heats the air that is discharging from the air store, usually one heated indirectly by combustion (e.g. of a fossil fuel). Such an arrangement is less efficient than a direct combustor and may be more difficult to keep in readiness to respond.

When a heater system is provided to heat air discharging from the air store, the GT hybrid system may also be configured to charge the air store and in that case the airflow passageway network may further comprise a cooling system (heat extraction system) that removes thermal energy from compressed air being extracted from the GT system.

Where heat is not being stored in the CAES system (diabatic CAES) for subsequent return, some form of cooling system (e.g. cooling heat exchanger) to remove (and discard) heat of compression from the extracted air is desirable. Any further downstream compressors will require coolers (e.g. intercoolers, aftercoolers) again to remove heat prior to storage.

Alternatively, when a heater system is provided, power machinery other than the GT system may be provided to charge the air store with compressed air, either via the airflow passageway network or a separate airflow passageway network.

For example, a small (e.g. ambient air fed) intercooled compressor, or series of compressor stages, could charge a compressed air store such as a pipe store at a small mass flow rate, where the hybrid system is only required to provide (e.g. rapid) power modulation from storage on relatively rare occasions, such that recharging can be accomplished slowly using small power machinery.

The hybrid system may comprise a simple cycle gas turbine systems (OCGT), or form part of a combined cycle gas turbine system (CCGT), or any other suitable derivative combustion turbine plant.

There is further provided, in accordance with the first aspect, a hybrid combustion turbine power generation system (CTPGS) comprising:

a combustion turbine (GT) system comprising a compressor, a combustor and a turbine fluidly connected downstream of each other; and,

a compressed air energy storage (CAES) system integrated with the GT system via one or more fluid connections to the GT system so as to allow air to be extracted from, or injected into, the GT system;

wherein the CAES system comprises an airflow passageway network and associated valve structure leading from the one or more fluid connections to a compressed air store;

wherein the CTPGS comprises a controller and associated sensors to (i) alter the configuration of the compressor in order to obtain a desired modulation of the power output, and to simultaneously (ii) selectively adjust how much air to transfer as a compensatory mass flow between the CAES system and the GT system, via the one or more fluid connections, in order partially or fully to compensate for the reduction or increase in mass flow rate through the compressor.

The hybrid CTPGS may further comprise any one or more other features as outlined previously above.

In a further aspect, there is provided a method of modulating the power output of a hybrid combustion turbine power generation system (CTPGS) comprising:

a combustion turbine (GT) system comprising a compressor, a combustor and a turbine fluidly connected downstream of each other; and,

an adiabatic compressed air energy storage system (ACAES) integrated with the GT system via one or more fluid connections to the GT system so as to allow air to be extracted from, and/or injected into, the GT system;

wherein the ACAES system comprises an airflow passageway network and associated valve structure leading from the one or more fluid connections to a compressed air store via a first thermal energy store (TES) that removes and returns thermal energy to the compressed air upon charging and discharging the air store, respectively; and, wherein at least one further stage of power machinery is provided between the first TES and the air store; and,

the method comprising modulating the power output whilst air is passing respectively downstream through the compressor, combustor and turbine by increasing or decreasing the power output by, respectively, selectively reducing or increasing the mass flow rate of the air through the compressor by altering its configuration, and simultaneously selectively adjusting how much air to transfer as a compensatory mass flow between the ACAES system and the GT system via the one or more fluid connections, in order partially or fully to compensate for the reduction or increase in mass flow rate through the compressor, thereby minimising or preventing any change in mass flow rate through the combustor and turbine at least for a selected time period.

In a yet further aspect, there is provided a method of modulating the power output of a hybrid combustion turbine power generation system (CTPGS) comprising:

a combustion turbine (GT) system comprising a compressor, a combustor and a turbine fluidly connected downstream of each other; and,

an adiabatic compressed air energy storage system (ACAES) integrated with the GT system via one or more fluid connections to the GT system so as to allow air to be extracted from, and/or injected into, the GT system;

wherein the ACAES system comprises an airflow passageway network and associated valve structure leading from the one or more fluid connections to a compressed air store via a first thermal energy store (TES) that removes and returns thermal energy to the compressed air upon charging and discharging the air store, respectively; and,

wherein at least one further stage of power machinery is provided between the first TES and the air store;

the method comprising operating the GT system in an initial power generation mode in which air passes respectively downstream through the compressor, combustor and turbine of the GT system to generate power; and modulating the power to achieve a second power generation mode (e.g. with a second power output) by at least one of the following steps:

(i) increasing the power output by reducing the mass flow rate of the air through the compressor by altering its configuration, and simultaneously adjusting how much air to transfer between the ACAES system and the GT system, via the one or more fluid connections, such that the mass flow rate through the combustor and turbine remains unchanged;

(ii) decreasing the power output by increasing the mass flow rate of the air through the compressor by altering its configuration, and simultaneously adjusting how much air to transfer between the ACAES system and the GT system, via the one or more fluid connections, such that the mass flow rate through the combustor and turbine remains unchanged.

The following embodiments may be used in any of the aspects outlined above.

In one embodiment, the method comprises operating the GT system in an initial power generation mode in which air passes respectively downstream through the compressor, combustor and turbine of the GT system to generate power; and modulating the power to achieve a second power generation mode (e.g. with a second power output) by at least one of the following steps:

(i) increasing the power output by reducing the mass flow rate of the air through the compressor by altering its configuration, and simultaneously adjusting how much air to transfer between the CAES system and the GT system, via the one or more fluid connections, such that the mass flow rate through the combustor and turbine remains roughly unchanged;

(ii) decreasing the power output by increasing the mass flow rate of the air through the compressor by altering its configuration, and simultaneously adjusting how much air to transfer between the CAES system and the GT system, via the one or more fluid connections, such that the mass flow rate through the combustor and turbine remains roughly unchanged.

In step (i) the amount of air being extracted (e.g. to the CAES system or ancillary depressurisation apparatus) may be reduced, or the amount of air being injected from the CAES system may be increased, or, both of those occur. In step (ii) the amount of air being injected from the CAES system may be reduced, or the amount of air being extracted to the CAES system or ancillary depressurisation apparatus may be increased, or, both of those occur. In step (i) or (ii) the CAES may switch from operating in any of an inactive mode or discharging mode or charging mode, to any other such mode, providing the CAES system can be configured with the appropriate responsiveness to meet the Improved Response time period.

In one embodiment, the power output is initially increased by conducting a step (i) whereby the mass flow rate within the combustor and turbine remains unchanged, and is then further increased by conducting a subsequent step (I) whereby the mass flow within the combustor and turbine is increased. For example, the mass flow rate of the air through the compressor may be reduced in a fast initial step (i) by making the guide vanes less open so as to increase the GT power output while the CAES compensates to keep the downstream (i.e. downstream of the flow connections) GT conditions unchanged. The overall power output may then be further increased by making the guide vanes more open and allowing the downstream mass flow rate (and pressure and temperature) in the GT system rise in a slower timeframe. Alternatively, or in addition to re-opening the guide vanes, the CAES may inject some air at a chosen mass flow rate into the GT system such that the downstream GT mass flow rate now rises and the overall power output increases.

Alternatively, in a further embodiment, the GT power output is initially decreased by conducting step (ii) whereby the mass flow rate within the combustor and turbine remains unchanged, and is then further decreased by conducting a subsequent step (II) whereby the mass flow within the combustor and turbine is decreased.

### BRIEF DESCRIPTION OF THE FIGURES

Specific embodiments of the present invention will now be described, by way of example only, with reference to the accompanying drawings in which:

FIG. 1 is a graph showing the variation of power output of a gas turbine with ambient temperature;

FIG. 2 is a schematic diagram of an industrial gas turbine and its ancillary ducting;

FIGS. 3a to 3e are schematic diagrams showing how power output may be modified in a hybrid combustion turbine power generation system (CTPGS);

FIGS. 4a to 4c are schematic diagrams showing how power output may be modified in a CTPGS according to a first embodiment of the present invention;

FIGS. 5a to 5c are schematic diagrams showing how power output may be modified in a CTPGS according to a second embodiment of the present invention;

FIGS. 6a to 6c are schematic diagrams showing how power output may be modified in a CTPGS according to a third embodiment of the present invention;

FIGS. 7a to 7c are schematic diagrams showing how power output may be modified in a CTPGS according to a fourth embodiment of the present invention, while a modified CTPGS with a vent valve is shown in FIG. 7d as an alternative to FIG. 7b;

FIGS. 8a to 8f are schematic diagrams showing how power output may be modified in a CTPGS with a hot gas expander according to a fifth embodiment of the present invention;

FIGS. 9a to 9d are schematic diagrams showing how power output may be modified in a CTPGS with a hot gas expander according to a sixth embodiment of the present invention;

FIGS. 10a to 10c are schematic diagrams showing how power output may be modified in a CTPGS according to a seventh embodiment of the present invention, as an alternative to that of FIGS. 4a to 4c;

FIGS. 11a to 11d are schematic diagrams showing how power output may be modified in a CTPGS with a vent valve according to an eighth embodiment of the present invention;

FIGS. 12a to 12c are schematic diagrams showing alternative systems for heating air during an injection mode;

FIG. 13 is a schematic diagram of a CTPGS according to a further embodiment of the present invention;

FIG. 14 is a schematic diagram of a CTPGS according to a yet further embodiment of the present invention; and,

FIGS. 15a and 15b are respective flow logic diagrams illustrating preferred operating modes and steps according to the present invention.

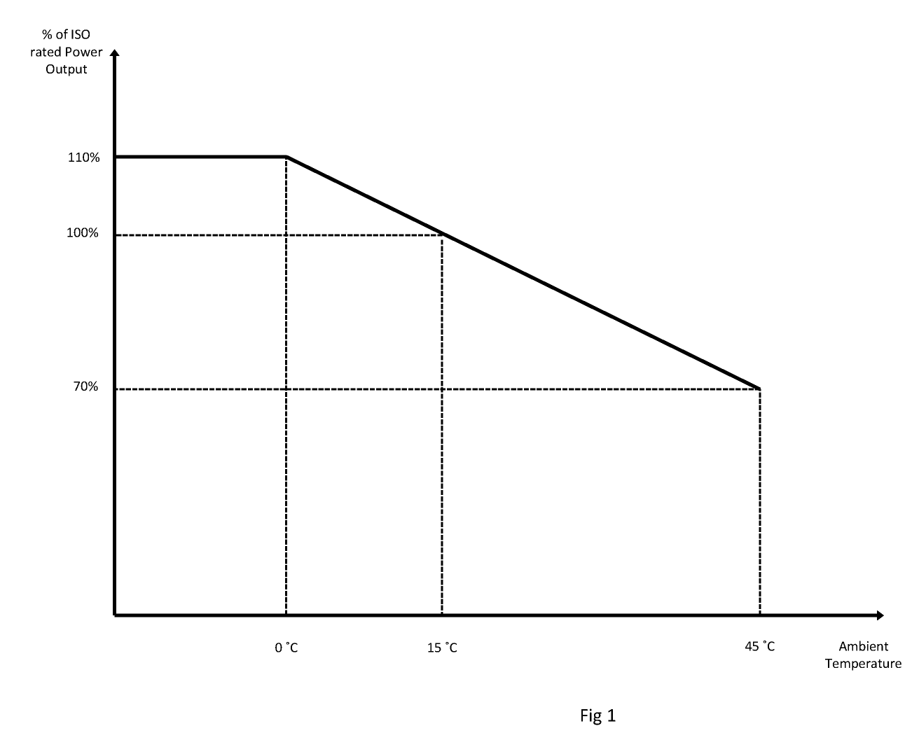

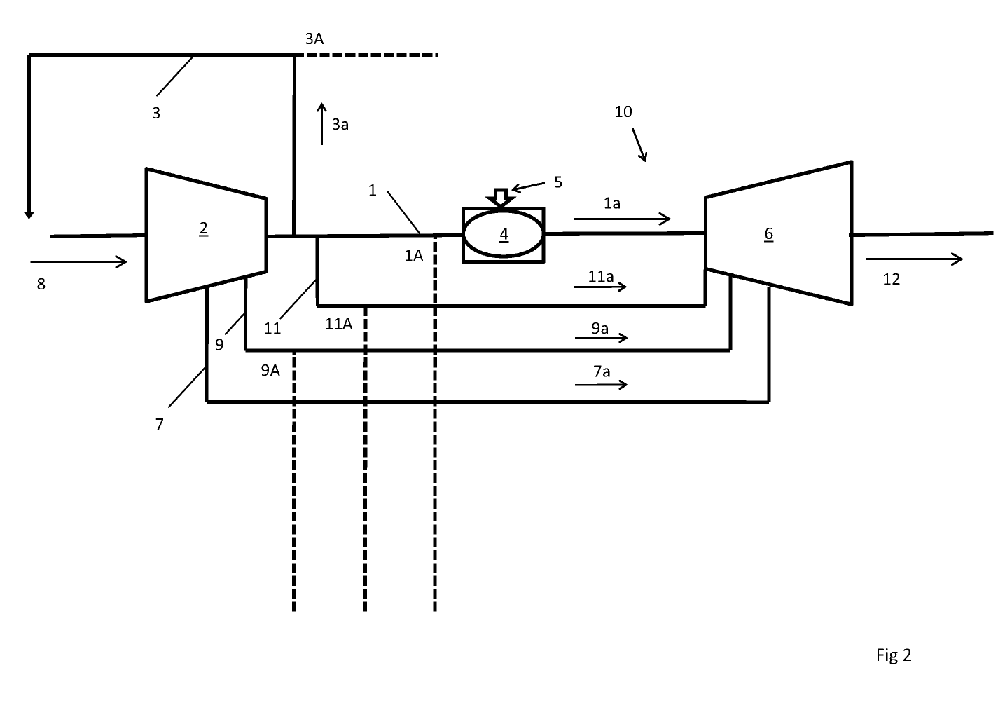

FIG. 2 shows a typical layout of a conventional prior art industrial gas turbine 10 used for power generation, with an upstream compressor 2 directly coupled to a downstream turbine (expander) 6 and driving a generator (not shown) connected to a transformer/grid. Between compressor 2 and turbine 6 is a combustion chamber 4 supplied with natural gas 5. In a normal configuration the compressor, turbine and generator are all directly coupled on the same shaft by drive couplings (not shown). Filtered air 8 enters the compressor at ambient conditions (e.g. 30° C., 1 bar) and is compressed up to a higher pressure and temperature (e.g. 400° C., 16 bar). The hot high pressure air enters the combustion chamber 4 where it is mixed with natural gas and caused to combust, heating the gas to a much higher temperature (e.g. 1400° C., 16 bar). This air is then expanded back to atmospheric pressure in the turbine 6 and leaves as heated exhaust gas 12. The turbine produces more power than the compressor absorbs, resulting in a net generation of power that can drive the generator.

In the case of an open cycle gas turbine (OCGT), the cooled air is exhausted from the turbine 6 well above ambient temperature (e.g. 450° C., 1 bar). However, in the case of a combined cycle gas turbine (CCGT), the turbine 6 operates with an exhaust temperature that is slightly hotter, either by operating at a lower pressure ratio or by combusting to a higher turbine inlet temperature. The exhaust gas 12 from the turbine 6 then enters a steam turbine system (passing through a heat recovery steam generator or HRSG) where further power is extracted in a steam bottoming cycle.

In the Figures that follow, all embodiments are depicted as simple cycle gas turbine systems (OCGT) for simplicity, but may instead form part of a combined cycle gas turbine system (CCGT), or any other suitable derivative combustion turbine plant. Furthermore, all embodiments relate to a conventional combustion turbine arrangement in which the compressor, combustor and turbine are permanently fluidly connected downstream of each other, so that whenever the gas turbine is operating at least some air flow passes successively downstream through all those components in turn, regardless of whether or not a portion of the flow is being extracted or augmented at the one or more fluid connections, and in that the turbine is non-detachably coupled to the compressor so that both operate together when power is being generated by the turbine.

As also shown in FIG. 2, a gas turbine will usually have a number of ancillary air flow passageways or fluid connections aside from the main passageway 1. Air may be injected or extracted at a fluid connection (dotted line) 1A to the main passageway. However, other potential air injection or bleed points are also shown on FIG. 2 by dotted lines.

For example, there is normally a fluid connection or duct 3 that feeds hot compressed air 3a from the compressor discharge plenum (between the compressor exit and the turbine inlet) back to a discharge valve located near the compressor inlet. Hot air is isenthalpically expanded back to atmospheric pressure and added to the inlet air 8 to increase the temperature. This is normally used to prevent ice formation at the entrance to the compressor, but can also be used to reduce the power output of the gas turbine. This connection 3 is known as the anti-icing line or inlet bleed heat line (IBH), and it is possible to connect to this line to either inject or bleed air from the gas turbine, as shown by dotted line 3A.

A further series of fluid connections or ducts 7, 9, 11 from different stages of the compressor may be used to keep the turbine blades cool by providing Turbine Cooling Air (TCA) 7a, 9a and 11a (at different pressures). As much as 15% of the air passing through a gas turbine can be used as TCA and does not pass through the combustor 4. The air 11a for the high pressure stages is taken from the compressor discharge plenum or the later stages of the compressor 2, while cooling air 7a, 9a for the later stages of the turbine is normally taken from an intermediate pressure stage. There may be a number of different pressure supplies to both the rotating and static turbine blades. Again, air can be injected into or extracted from the TCA ducts (e.g. at points 9A, 11A) rather than directly into the gas turbine main passageway 1. If a quantity of air that is less than the normal TCA supply is injected (normally in the higher pressure lines), then the TCA flow from the compressor will be reduced by a similar amount. If a quantity of air that is greater than the normal TCA supply is injected (normally in the higher pressure lines), then the TCA flow will be forced to reverse and enter the GT back through the normal inlet to the TCA duct. Injected airflow will thus start to displace and even completely replace the TCA. The actual injected air will not pass through the combustor 4 (unless it exceeds the normal quantity of TCA as mentioned above), but instead will pass directly to the turbine section of the gas turbine. However, the air that would have passed through the TCA line will now pass through the combustor instead with the same result as if the air had been directly injected into the main passageway 1.

Likewise bleeding air from the TCA line will increase the amount that is withdrawn by the TCA line; however, it is important that the amount of cooling air is not reduced by the bleed such that it fails to provide adequate cooling to the turbine section.

In addition to such ports, it is also possible to adapt the casing or casings to allow for additional injection points.

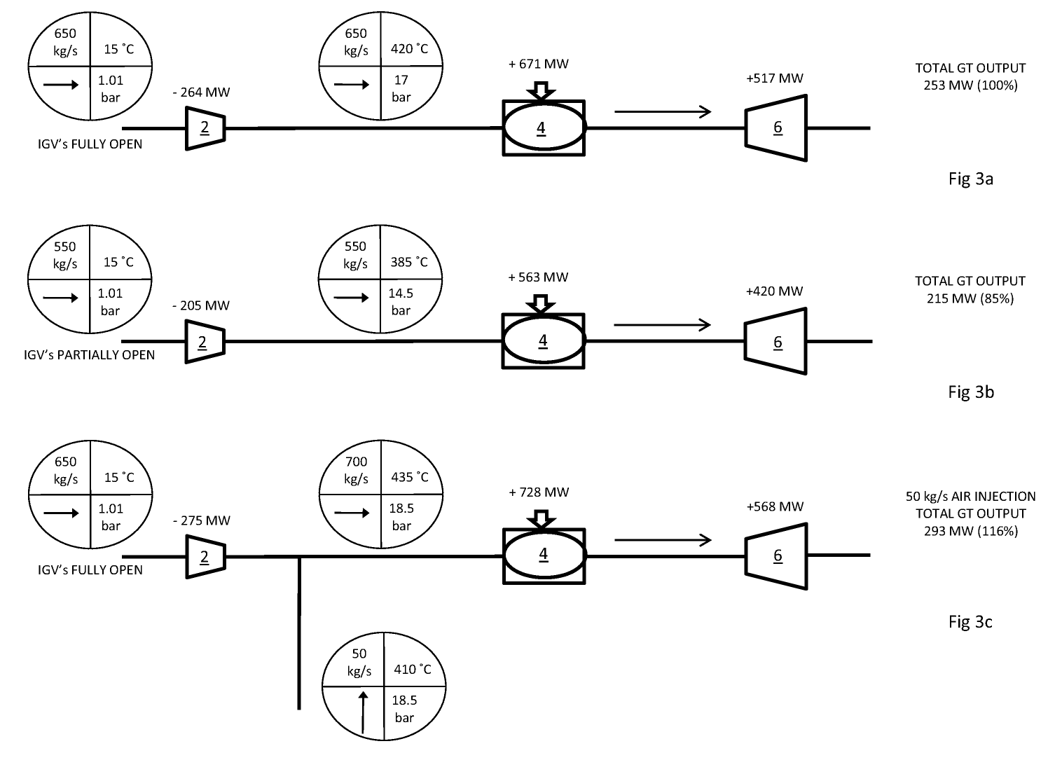

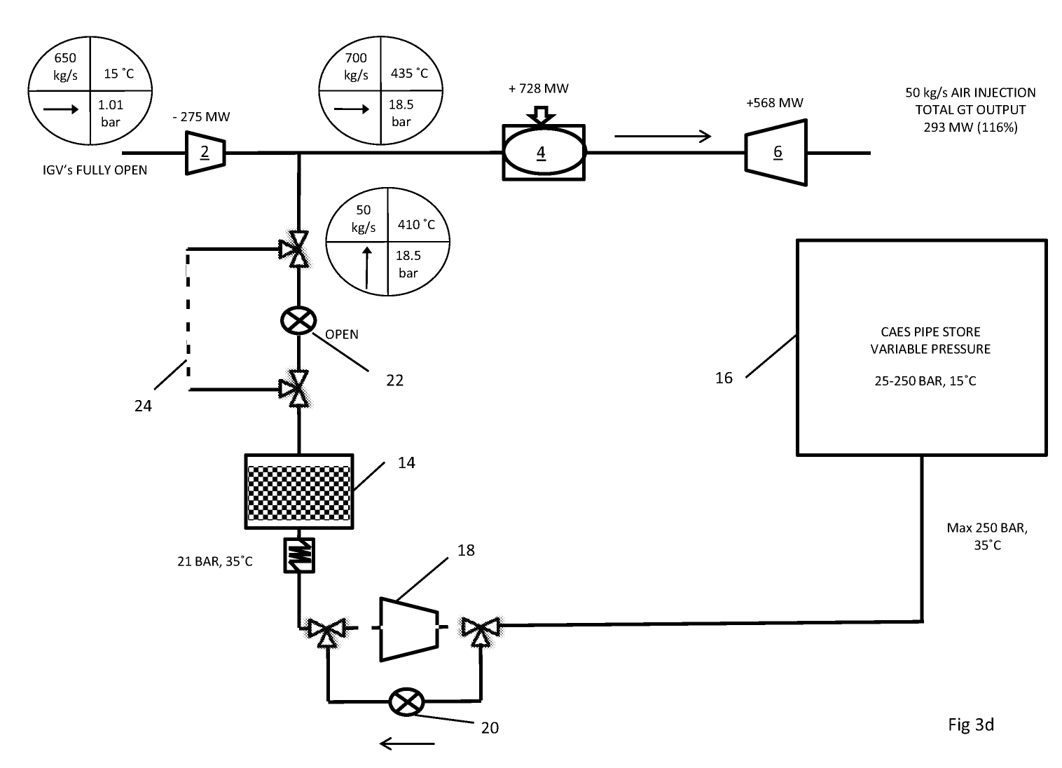

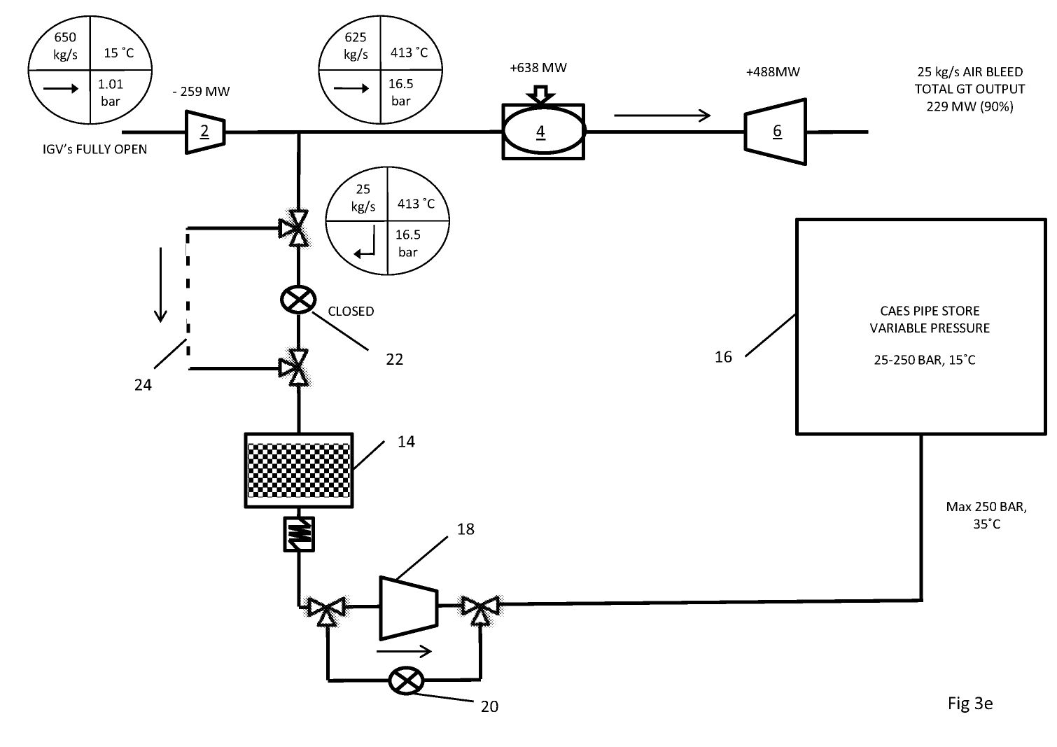

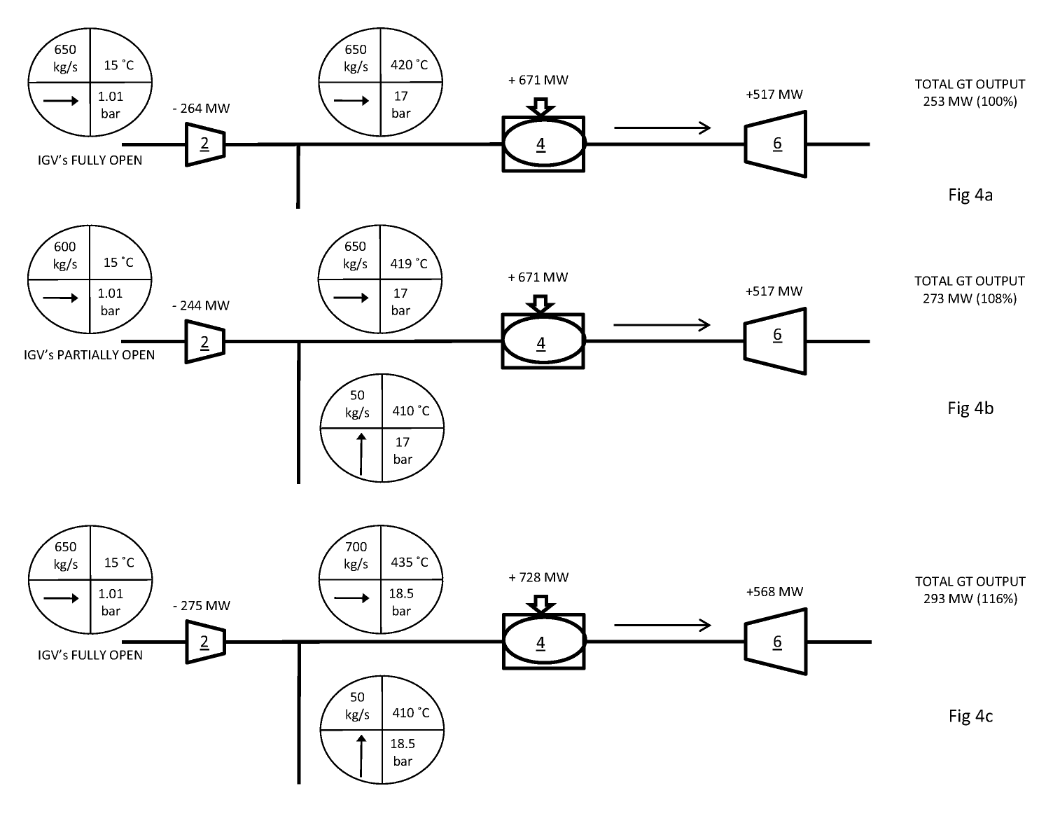

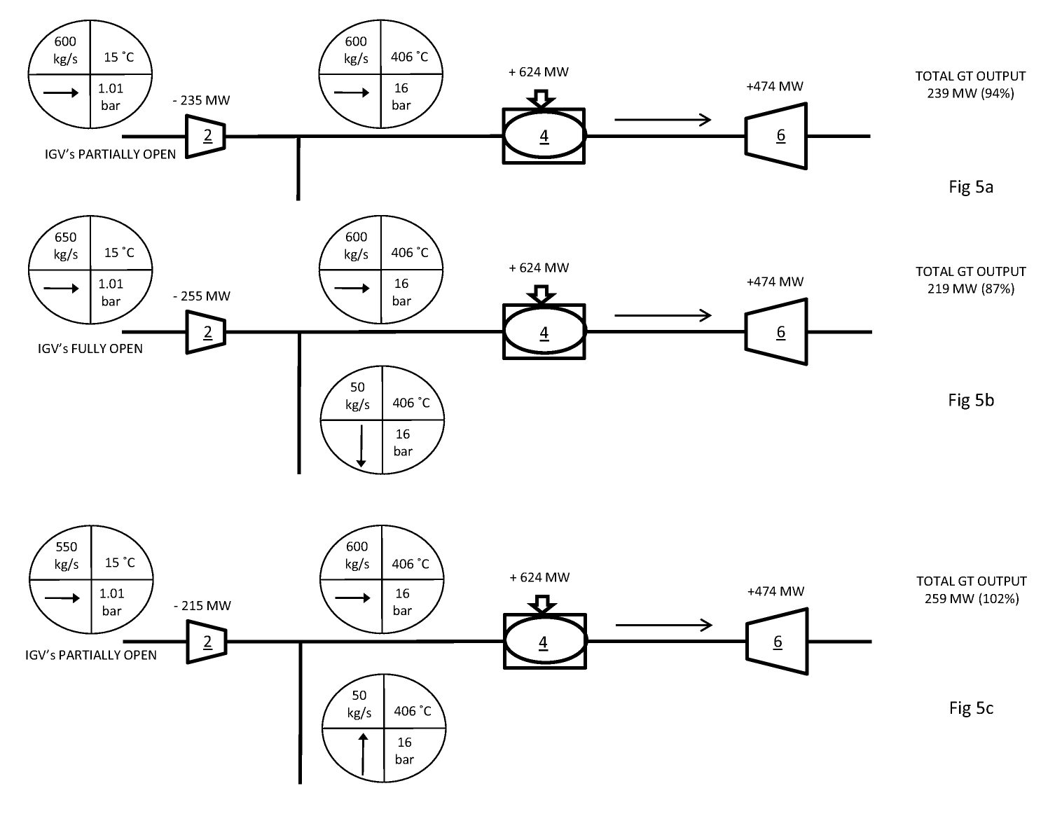

FIGS. 3a to 3e are comparative examples showing how power output is usually modified in prior art hybrid combustion turbine power generation systems (CTPGS), while FIG. 4a onwards are examples illustrating how power may be modulated in accordance with the present invention. In all the examples, numerical values have been approximated and simplified (e.g. based on constant heat capacity values) and are merely intended to be illustrative of the principles being discussed.

A gas turbine usually has inlet guide vanes used to control the mass flow entering the compressor, which on a large industrial gas turbine can reduce mass flow by about 30%, thereby usually leading to a reduction in the GT power output.

Referring first to FIG. 3a, this shows a normal gas turbine (GT) operating at 100% load (allowing for ambient air conditions) with Inlet Guide Vanes (IGV's) fully open. Mass flow into the compressor 2 is 650 kg/s and the temperature post compression is 420° C. and the pressure is 17 bar.

FIG. 3b shows the same GT operating in a Frequency Response (FR) mode, where it is required to provide additional power to the grid within 10 seconds. Power output is 85% of the normal GT power output whilst in this mode. The IGV's are partially open and the mass flow into the compressor is 550 kg/s. The temperature post compression is 385° C. and the pressure is 14.5 bar. For the gas turbine to switch from this mode of operation to that shown in FIG. 3a over a 10 second period it is necessary to increase the mass flow through the compressor by opening the IGV's. As the mass flow through the gas turbine is increased the exhaust temperature starts to drop and the gas flow to the combustor is increased. It can be seen that the mass flow increases by approximately 100 kg/s over a 10 second period i.e. 10 kg/s².

There are two limitations on the rate at which air can be injected. The first is related to thermal stresses. As the pressure ratio changes, the temperature in the compressor and turbine sections both change and this can lead to thermal stresses that are potentially damaging to the gas turbine and can lead to increased maintenance and likelihood of unpredicted enforced outages. The second concern is combustor stability. DLN (Dry Low NOx) combustors normally operate on a very lean mixture and it is possible to ‘blow’ them out if the air fuel ratio is changed too quickly. Using a less lean mixture can help the stability of the combustor, however this is not suitable for normal operation as it leads to an increase in NOx production.

FIGS. 3c to 3e illustrate how power may be modulated when the GT forms part of a hybrid system. FIG. 3c shows the same gas turbine operating at full load where hot compressed air is being injected into the gas turbine. Mass flow into the compressor is 650 kg/s with an additional 50 kg/s being injected at approximately the same temperature post the compressor. The temperature post compression is 435° C. and the pressure is 18.5 bar.

Systems like this have been proposed by Powerphase, Nakhamkin and the Applicant. The aim in such systems is to increase the mass flow through the combustor and turbine without passing through the compressor. This means that for an injection of, say, 50 kg/s of air in to a GE 9FA gas turbine, the gas turbine power can increase to 116% of the rated power at that ambient condition. On the basis that in normal Frequency Response mode the mass flow rate can be increased at a rate of 10 kg/s², then a 50 kg/s increase (from air injection) can be achieved over a 5 second period.

FIG. 3d shows the entire hybrid system operating in a discharging mode to deliver 50 kg/s of hot compressed air, as required for FIG. 3c. This system comprises a direct TES 14 and downstream heat exchanger, an intercooled compressor 18, two pressure reducing valves 22 and 20 and a compressed air store 16. The system is discharging at a rate of 50 kg/s from the compressed air storage 16 through the first valve (bypassing the intercooled compressor 18) and then through the TES 14, where the gas is reheated, before passing through the open high speed valve 22 into the gas turbine at the fluid connection. The fluid connection in this, and all subsequent figures, may be any one or more suitable connections or ports to the GT, as described above in relation to FIG. 2, and the same or separate respective connections may be used for injection and extraction (bleed).

In FIG. 3e the same system is shown, but in a charging mode where 25 kg/s is being bled from the gas turbine at the fluid connection. The hot air passes through the TES 14 where the heat is stored. The now cooled (but pressurised air) exits the TES and is compressed up to the pressure in the compressed air storage by the intercooled compressor 18. The pressure in the compressed air store 16 normally increases as additional air is added to the store, unless a constant pressure store is used.

It is preferable that the thermal store 14 and connecting pipe to the fast acting valve 22, located close to the gas turbine, is pressurised slightly above the operating pressure of the gas turbine 2/4/6. The advantage of this is that the response time of the air injection will be faster and it allows for more accurate control of the flow rate that is being injected, which is desirable to protect the gas turbine. In addition there may also be an additional pressure let-down valve 20 or other pressure reducing device from the compressed air store to drop the pressure of the air to that of the pressure within the heat store. For example, the compressed air store may be at 250 bar, the air in the TES at 20 bar and the operating pressure in the gas turbine 17 bar. In this way when additional power is required, the fast acting valve 22 opens at a controlled rate (determined by the type of gas turbine) to inject additional air into the gas turbine and the additional valve 20 opens to ensure that the pressure in the TES stays at approximately 20 bar. It should be noted that where there is a direct thermal store it is likely that there is a significant buffer of residual air in this store and hence the pressure variation in the store will be relatively slow if the additional valve 20 is used to control the rate of air injection. This is also the reason why it is preferable to use a fast acting valve close to the gas turbine where the supply is above the operating pressure of the gas turbine.

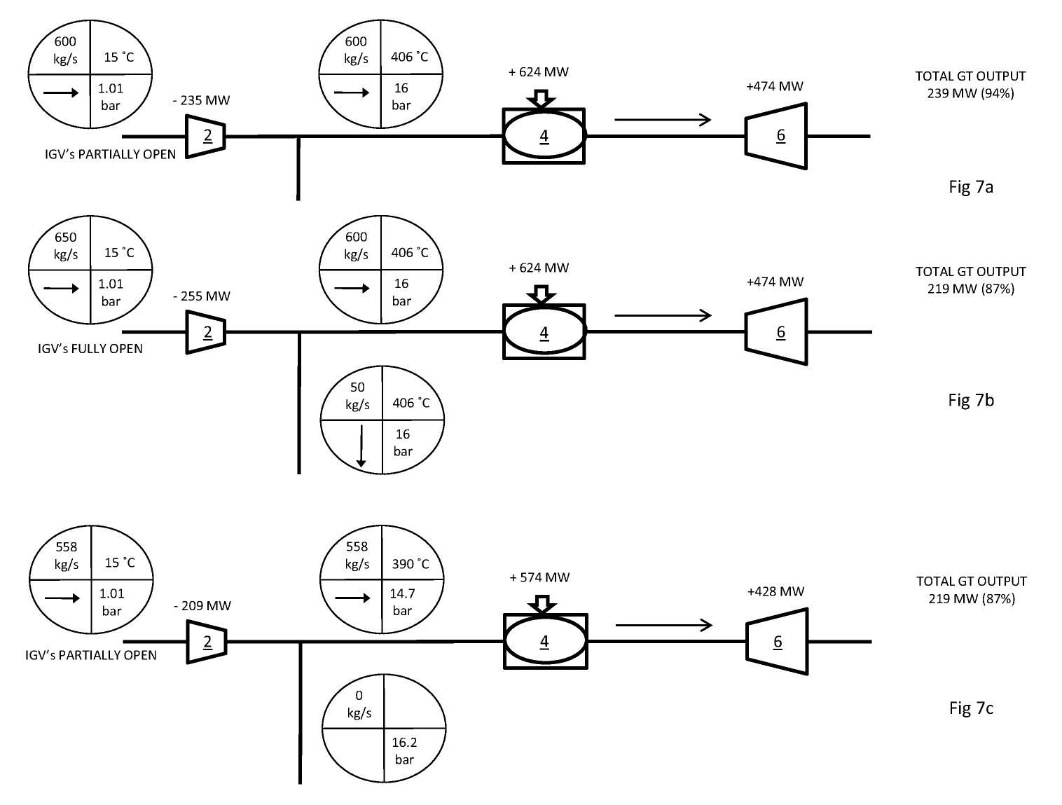

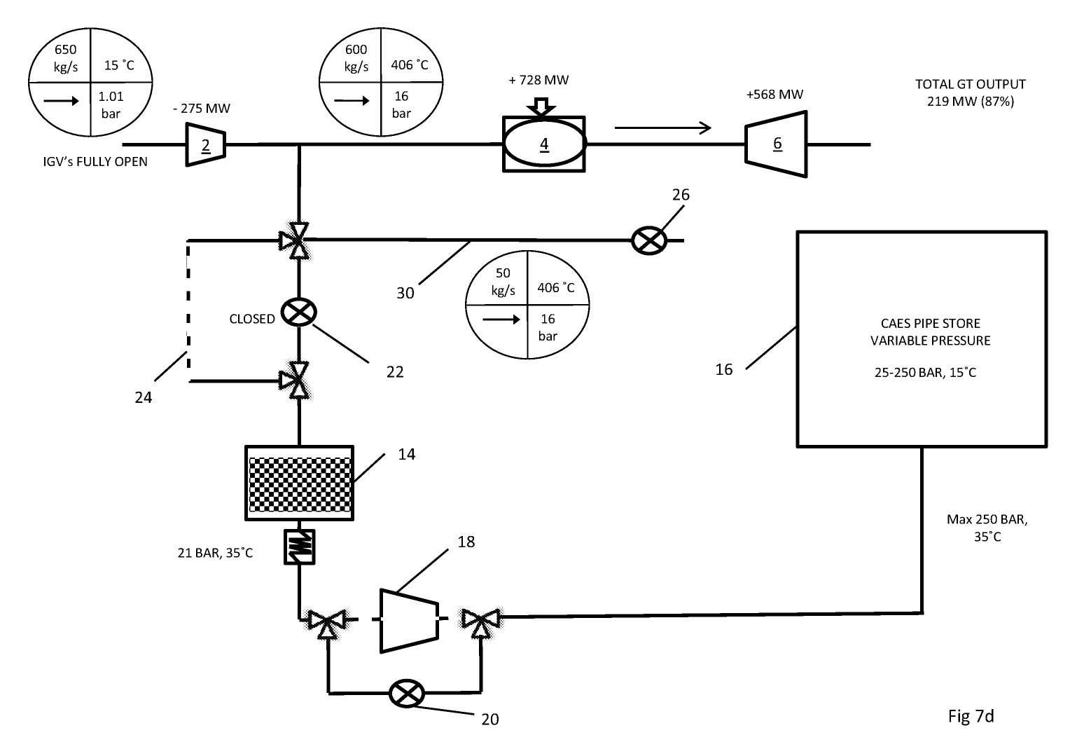

FIGS. 4 to 7 show, by way of example, various methods according to the invention for increasing the rate of change in power output of a gas turbine hybrid system over a much shorter period of time, whilst avoiding the normal limitations of thermal stress and combustor stability. Those figures (except for the modified system shown in FIG. 7d) are based on the hybrid system of FIGS. 3d & 3e, although the ACAES system has been omitted for simplicity.

Referring to FIG. 4a, the gas turbine hybrid system is operating at 100% load (allowing for ambient air conditions) with Inlet Guide Vanes (IGV's) fully open. Mass flow into the compressor is again 650 kg/s and the temperature post compression is 420° C. and the pressure is 17 bar. No additional air is being injected from the hot air injection system.

FIG. 4b shows the same system operating with the IGV's partially open (the mass flow through the compressor has dropped to 600 kg/s) and with the 50 kg/s air injection from storage. The important point to notice is that the post compression pressure and temperature are the same as for FIG. 4a. The mass flow through the combustor is also the same. Consequently, there is no change to any of the temperatures or pressures within the machine, which means thermal stresses are not an issue. The air flow mass through the combustor is also constant so there are no issues with combustor stability. However, the power output of the gas turbine is 8% higher.

The change from the system operating in the mode of 4a to the mode of 4b can be achieved by closing the IGV's at the same time as additional air is injected into the gas turbine to compensate for the reduction in mass flow through the compressor. That process can also be rapidly reversed from mode 4b) back to mode 4a) by re-opening the IGV's, whilst reducing the amount of air injected. As combustor stability is no longer an issue, the one remaining technical constraint is compressor surge. If too much air is injected then it is possible to stall or surge the compressor. This limit will vary from gas turbine to gas turbine, but the upper limit is normally around 10% additional mass flow.

This method allows the power output of a gas turbine to be varied by around 10% within as little as 1-2 seconds without imposing any thermal stresses on the gas turbine or risking combustor instability. Note the actual change will be a function of the ability of the compressor to deal with the additional mass flow. At 10% air injection, the increase in power would be around 13% to the GT output.

The system operating in FIG. 4b mode can further increase power output to the grid by an additional 8% over a slower time of about 5 seconds by opening the IGV's. This is shown in FIG. 4c, where the compressor returns to the original mass flow of 650 kg/s. This increase in mass flow can be achieved over 5 seconds—i.e. it increases by 10 kg/s² over 5 seconds. Thus:—

FIG. 4a to FIG. 4b illustrates: Increasing a rate of air injection into a gas turbine while simultaneously reducing the mass flow through the compressor with the IGV's to reduce compressor power and generate an increase in GT power output, whilst maintaining mass flow rate through the combustor and turbine (and hence pressure and temperature conditions) unchanged.

FIG. 4b to FIG. 4a illustrates: Reducing a rate of air injection into a gas turbine while simultaneously increasing the mass flow through the compressor with the IGV's to increase compressor power and generate an reduction in GT power output, whilst maintaining mass flow rate through the combustor and turbine (and hence pressure and temperature conditions) unchanged.

FIG. 4a to FIG. 4b to FIG. 4c illustrates: Increasing a rate of air injection into a gas turbine while simultaneously reducing the mass flow through the compressor with the IGV's to reduce gas turbine compressor power and generate an increase in GT power output whilst maintaining mass flow rate through the combustor and turbine (and hence pressure and temperature conditions) unchanged. This is followed by opening the IGV's afterwards further to increase power output over a longer time period.

FIGS. 4a-c show how power may be rapidly increased. It will be appreciated that this requires careful control of the hybrid system. To that end, the hybrid system will usually comprise a controller and associated sensors to (i) alter the configuration of the compressor in order to obtain a desired modulation of the power output, and to (ii) selectively adjust how much air to transfer as a compensatory mass flow between the CAES system and the GT system.

As regards suitable control of the system, there are a number of factors that affect how much the mass flow through a compressor will change as the position of its IGV's is changed including, for example, the ambient air density (i.e. ambient temperature and pressure), the pressure ratio over which the compressor is operating, and its relative age. For a given gas turbine, there will usually be a compressor map that takes into account these factors and makes it possible accurately to calculate how much the mass flow through the compressor will change as the position of the IGV's is changed. If the control law and response characteristics of the actuator that controls the IGV position are also known then it is possible to calculate accurately by how much the mass flow will change over time as the IGV is moved from one position to another.

The ACAES system will also need to rely on rapidly responding valves to give accurate mass flow control either into or out of the gas turbine, that broadly match the change in mass flow from the compressor. In general, flow is the result of a pressure difference between two spaces and the discharge coefficient of the interconnecting duct system. If the spaces are close together and have large connecting pipes (high discharge coefficient) then a high flow rate can be achieved with a small pressure drop. If the spaces are a long distance apart and the connecting pipe is smaller (low discharge coefficient) the result will be a higher pressure drop to achieve the same flow. In addition for fast acting systems there is a certain amount of energy required to accelerate or decelerate the flow that can lead to transient pressure drops when valves open.

In the hybrid system it is desirable to have rapidly responding valves that are able to deliver accurate amounts of mass injection or bleed from the gas turbine. Furthermore the location of the thermal stores and compressed air system may be some distance from the gas turbine. Consequently it is preferable when the system is in a frequency response mode (i.e. where it is able to inject air) that it is kept at a pressure that is above that in the gas turbine. This might be 0.5 bar higher, 1 bar higher or even 5 bar higher than the gas turbine operating pressure. The advantage of having this at a significantly higher pressure is that it is easier to provide an accurate mass flow rate if there is a higher pressure drop as any transient pressure changes to either side will have less impact on the actual mass flow through the device. In addition the size of the orifice is also reduced as it is possible for a greater mass flow to pass through a fixed sized hole if the pressure drop is increased.

In terms of the valve, there are two functions taking place. The first is to seal the higher pressure supply from the gas turbine. The second is to control the mass flow rate and how it varies over time. This means that it is possible to replace a valve that also controls the flow with a simple valve and a flow controller within the passageway. Such a flow controller can be either upstream or downstream of the valve. Either solution is acceptable and by using a combination of inlet temperature and pressure and outlet pressure it is possible, for example, to calibrate the device so that the mass flow at different settings is known. To ensure stable inlet temperatures (and flow rates) it is preferable to insulate and heat the connecting pipework to the gas turbine and any valves so that they are maintained at a temperature that is close to that of the thermal store and hence the air exiting the thermal store. Again if the actuator characteristics are known then it is possible to calculate accurately by how much the mass flow will change over time as the valve is opened and the size of the opening provided.

In this way it is possible for both the IGV's and valves to be changed simultaneously so that the variation in mass flow through the combustor and turbine is kept minimal. Whilst it would be possible to use sensors and feedback loops to adjust the flow rates, for a faster acting system, it is preferable if this can be avoided as it is likely to lead to delays.

For fine tuning and recalibration while operating it is likely that such sensors will be useful. For example it may be possible simply by measuring the change to the gas turbine to estimate whether the model of either system is changing with time due to wear and tear. For example if both the IGV's and the valve are moved to positions that reduce the mass flow through the compressor and increase the rate of air injection and the pressure in the gas turbine rises more than expected then one option could be that the gas turbine compressor has degraded slightly. To compensate for this either the IGVs need to be closed slightly further or the rate of air injection (i.e. flow controller open area) needs to be reduced. As it is likely that changes will occur over time this should allow for accurate remapping of the relative performance of each system over time.

Whilst a mapping and calibration approach may be used to limit the mass flow variation through the combustor during power modulation, it may also be feasible that a model based controller could also be used to achieve the same end result. Such a controller might contain equations or code that describe the physical models of the compressor, IGV hardware, gas turbine and the ACAES system with associated control valves etc. Such an approach might result in a control system that is able to cope with the complex interactions, non-linearity and delays that would otherwise have to be extensively mapped to achieve a stable and fast-responding system.

Turning now to FIGS. 5a-c, these show how power in a hybrid system may be adjusted both up and down equally quickly.

In FIG. 5a, the gas turbine is operating at 94% load (allowing for ambient air conditions) with Inlet Guide Vanes (IGV's) partially open. Mass flow into the compressor is 600 kg/s and the temperature post compression is 406° C. and the pressure is 16 bar. No additional air is being injected from the hot air injection system.

FIG. 5b shows the same gas turbine operating with the IGV's fully open (the mass flow through the compressor has increased to 650 kg/s) and with a bleed rate of 50 kg/s. However, once again the post compression pressure and temperature are the same as for FIG. 5a and the mass flow through the combustor is also the same. Consequently, there is no change to any of the temperatures or pressures within the machine, which means thermal stresses are not an issue. The air flow mass through the combustor is also constant so there are no issues with combustor stability. However, the power output of the gas turbine in FIG. 5b has dropped by 7% (20 MW) compared to that of FIG. 5a.

The change from the system operating in the mode of FIG. 5a to the mode of FIG. 5b may be achieved by opening the IGV's at the same time as additional air is bled from the gas turbine to compensate for the increase in mass flow through the compressor. That process can also be rapidly reversed from mode 5b) back to mode 5a) by partially closing the IGV's, whilst reducing the amount of air being bled. As combustor stability is no longer an issue, the one remaining technical constraint is compressor surge. Bleeding air increases the surge margin so this risk is actually reduced.

FIG. 5c shows the same system operating with the IGV's partially open (the mass flow through the compressor has dropped to 550 kg/s) and with the 50 kg/s air injection. The important point to notice is that the post compression pressure and temperature are the same as for FIGS. 5a and 5b. The mass flow through the combustor is also the same. Consequently, there is no change to any of the temperatures or pressures within the machine, which means thermal stresses are not an issue. The air flow mass through the combustor is also constant so there are no issues with combustor stability. However, the power output of the gas turbine in FIG. 5c is 8% higher (20 MW) that that of FIG. 5a.

The change from the system operating in the mode of FIG. 5c to the mode of FIG. 5a and even FIG. 5b can be achieved by opening the IGV's at the same time as the air injection rate is reduced or even reversed (to bleed) to compensate for the increase in mass flow through the compressor. This method allows the power output of a gas turbine to be varied by around 10% up or down within 1-2 seconds without imposing any thermal stresses on the gas turbine or risking combustor instability. Note the actual change will be a function of the ability of the compressor to deal with the injected mass flow. At 10% air injection the increase in power will be around 13% to the GT output. Bleed rates can be higher.

The gas turbine used in these figures has a mass flow through the compressor at ISO conditions with IGV's fully closed of 450 kg/s and with IGV's fully open of 650 kg/s.

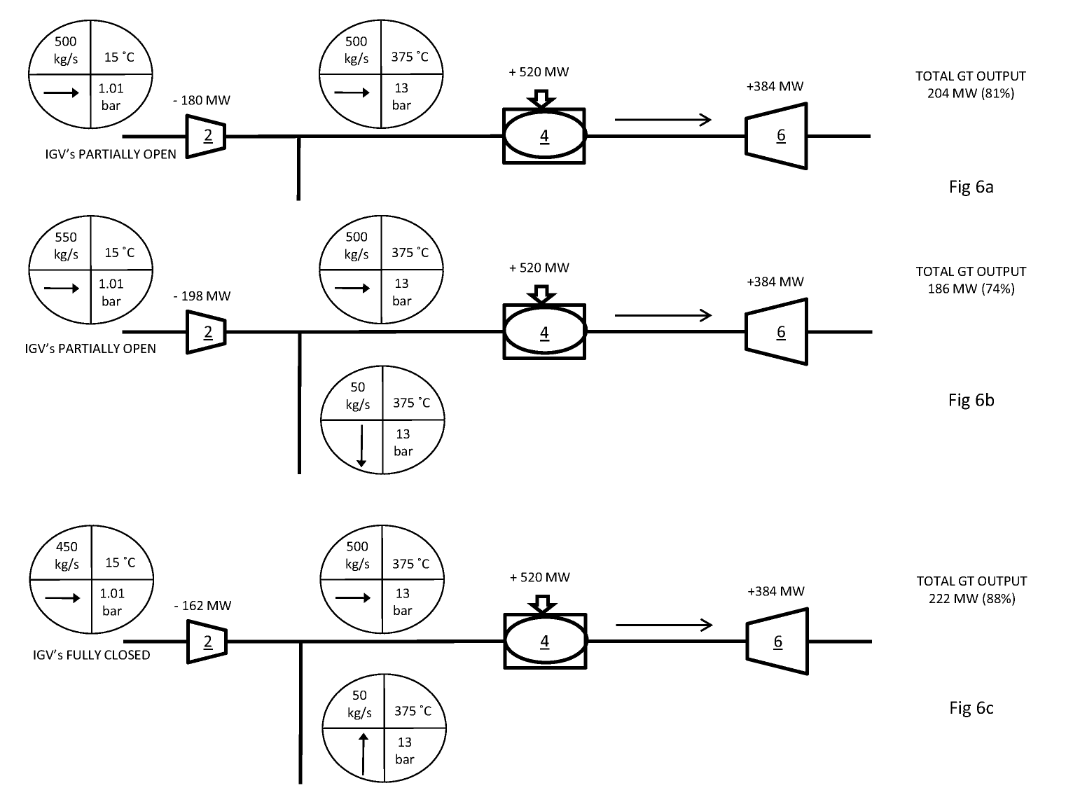

FIGS. 6a to 6c show the same GT system where it is operating at a lower power setting in an Initial Mode, but again where the output can be switched between the different modes (similarly to FIGS. 5a-5c) by selectively adjusting the IGV's and selectively adjusting the rate of air injection/bleed to provide a compensatory mass flow to ensure a near constant mass flow through the combustor. Thus, in FIG. 6a the initial GT power output is 204 MW, this can be rapidly reduced, as shown in FIG. 6b, to 186 MW by starting a bleed mode. Alternatively, from the initial power output in FIG. 6a, the power can be rapidly increased by starting an injection mode (e.g. from storage), as shown in FIG. 6c, to 222 MW.

FIGS. 5a-c and FIGS. 6a-c thus show that it is possible to vary the power output of the gas turbine while still maintaining the ability to turn the power up or down rapidly. In FIG. 5a this is an upper power band, whilst maintaining the same ability to modulate up and down, and FIG. 6a is a lower power band.

FIGS. 7a-7c show how it is possible to transition between different power outputs while maintaining the flexibility to turn up and down. FIG. 7a shows the same situation (i.e. 239 MW output, and 600 kg/s through combustor and compressor) as FIG. 5a, and FIG. 7b shows the same situation as FIG. 5b where the power output has been rapidly reduced, according to the method of the present invention, to 219 MW. FIG. 7c, however, then shows how the IGV's can be re-adjusted to change the mass flow through the combustor while reducing the rate of bleed to reset the gas turbine at the lower power output of 219 MW. This subsequent change will usually be conducted in a slower timeframe having regard to an acceptable rate of change of conditions in the combustor/turbine.

In FIG. 7d, the system has been modified to achieve rapid bleed rates by venting to atmosphere. To this end, a fast-acting vent valve 26 is provided within the CAES passageway network downstream of the fluid connection to the GT. The advantage of this is that high bleed rates can be managed for short periods of time without requiring the intercooled compressor to be designed for these high flow rates. The venting can be either before or after the TES 14. The valve could however be in fluid communication with one or more of the fluid connections via its own respective passageway, so as to allow its operation irrespective of the operational status of the CAES system.

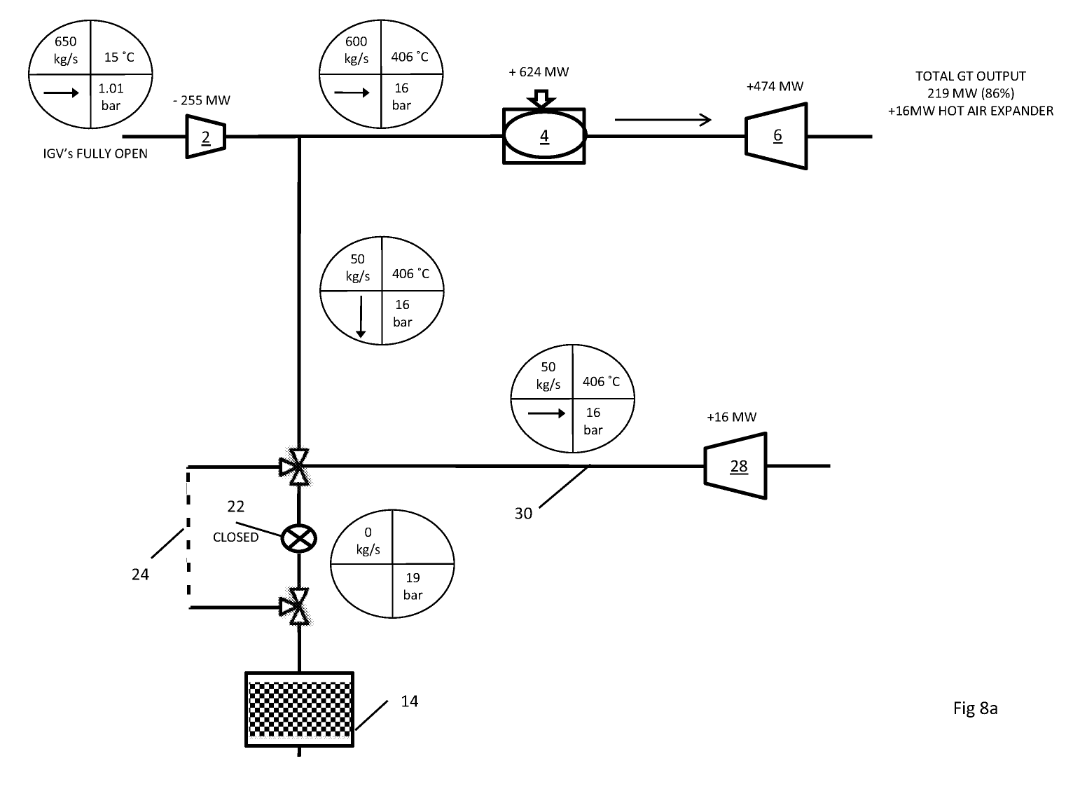

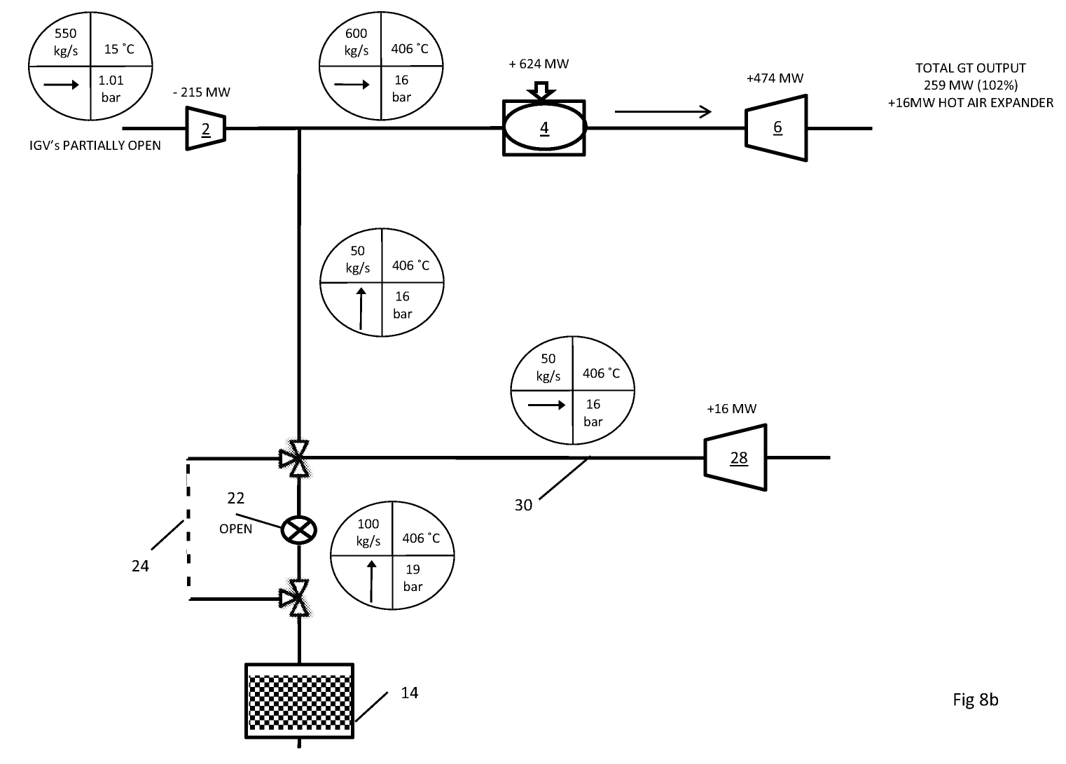

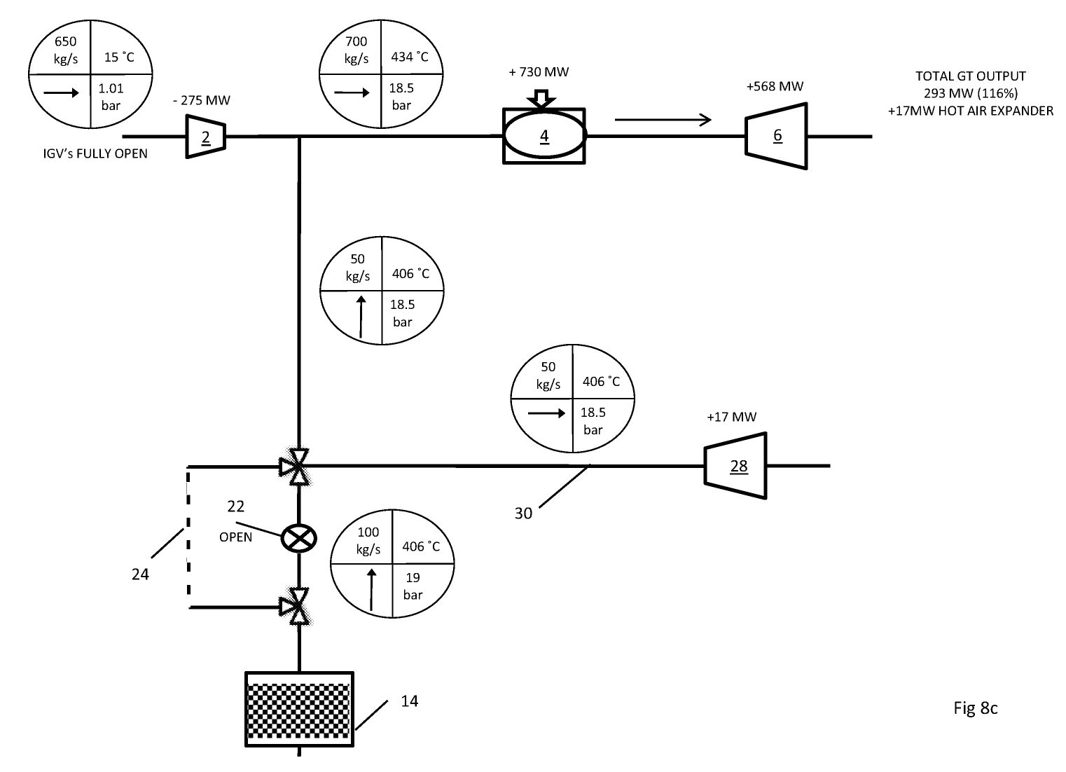

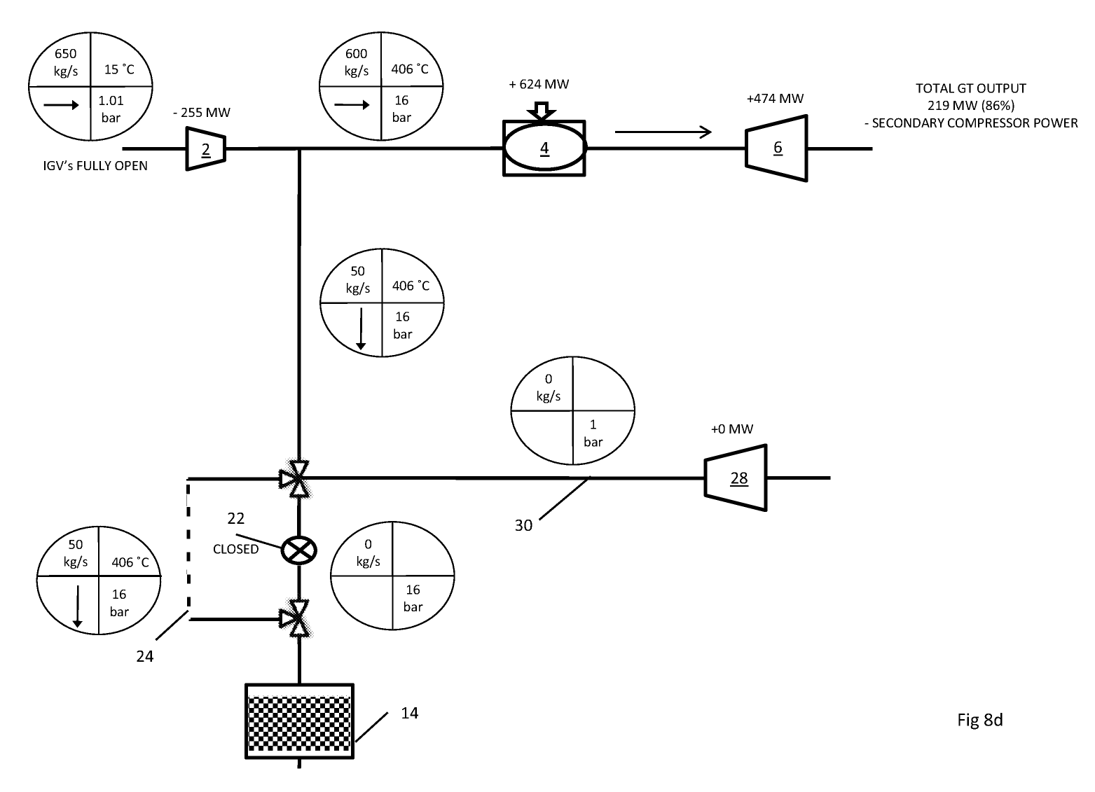

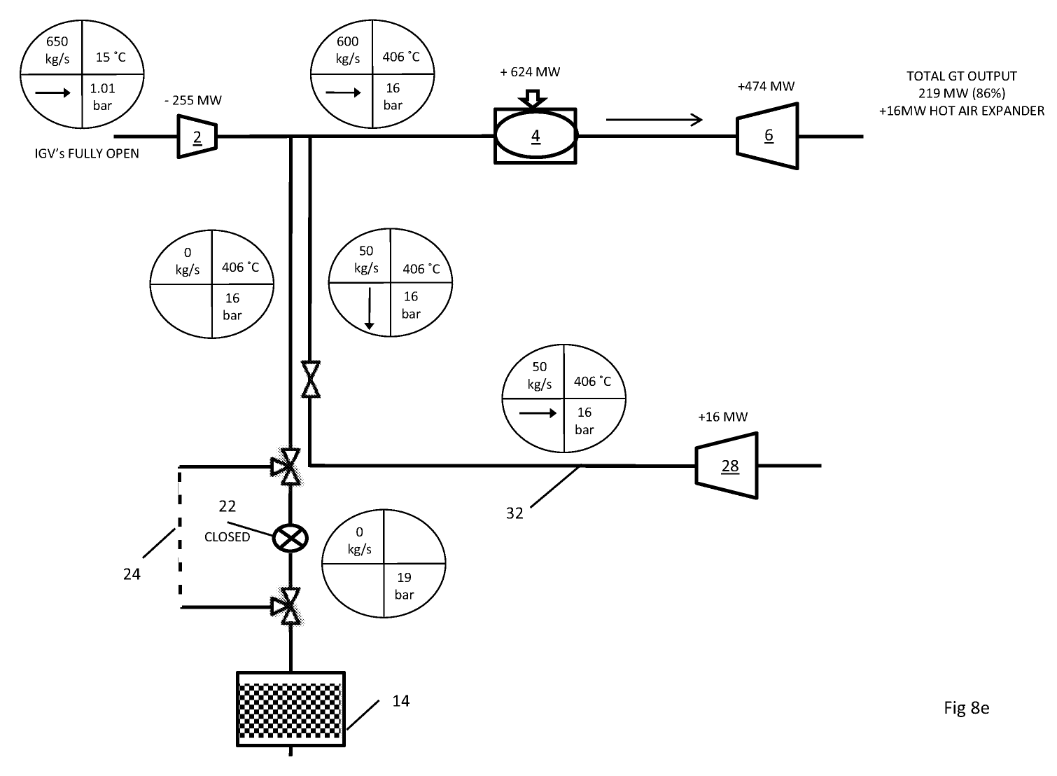

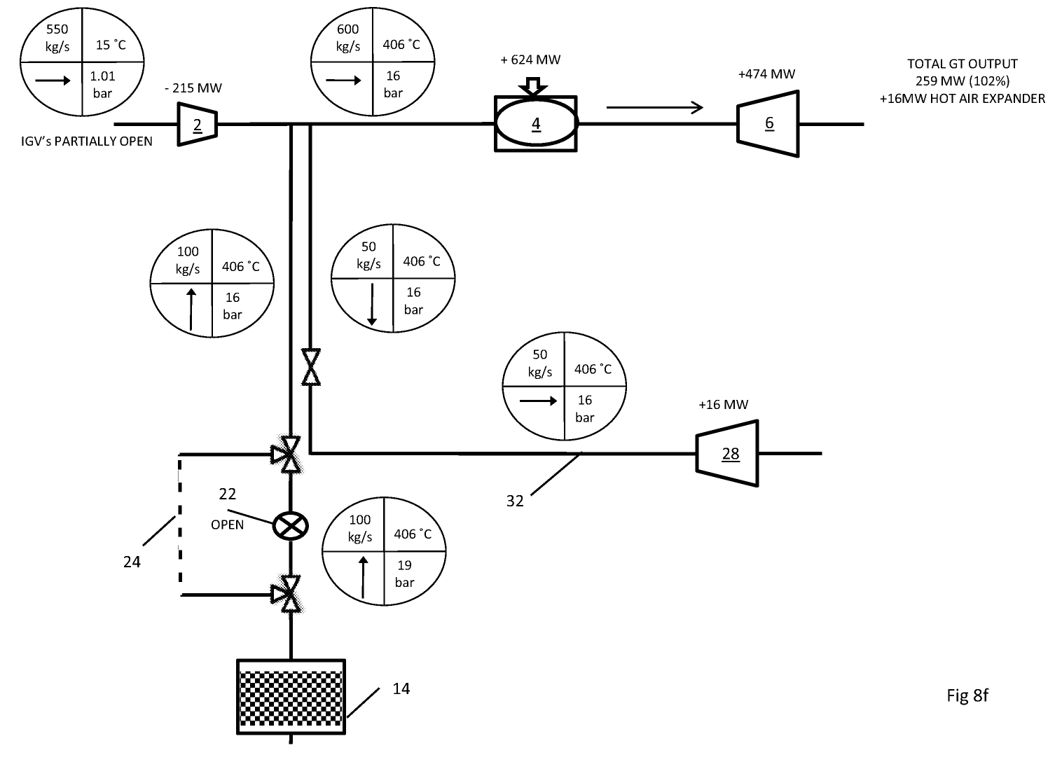

FIGS. 8a-8f show a method for increasing both the peak power output of a gas turbine hybrid power plant and for increasing the power range that can be managed in a short time period. In these examples, the hybrid system of FIGS. 3d/3e has been modified by the addition of a hot air expander 28, which can be a dynamic machine (axial flow, centrifugal, turbo-expander) or a positive displacement machine (reciprocating, rotary screw), or other suitable machines that extract useful work and can manage the temperature. For example, the hot air expander 28 may be based around a modified steam turbine as the temperatures are not dissimilar to those seen in steam turbine operation.

Referring to FIG. 8a, this shows the system with the same gas turbine operating with the IGV's fully open and 50 kg/s being bled from the gas turbine. As a consequence 600 kg/s of air is passing through the combustor and the temperature post compression is 406° C. and the pressure is 16 bar. The advantage of a bleed of compressed air is that it increases the amount that the gas turbine can be turned up by. For example there could be a grid requirement to be able to provide additional power rapidly over many hours. However, if the air is bled from the system and stored then it is likely there would be a significant quantity of thermal storage, power machinery and compressed air storage. In addition this hot compressed air will need to be re-injected at a later stage. During re-injection, because of the previously mentioned surge limits, it means that the ability to increase power further (by additional air injection) is significantly restricted.

The use of a hot air expander 28 means that the compressed air does not actually need to be stored (or re-injected) and hence the benefit of the increased upside in power range is provided without a large capital cost. Furthermore, the hot air expander 28 can add to the rated power capacity of the plant as long as there is stored hot compressed air. There are obviously losses associated with compressing and then re-expanding air, however the ability to vary power rapidly is valuable and may well outweigh the disadvantage of these higher losses. This is potentially a very low cost form of extra capacity. In this mode of operation the 50 kg/s is re-expanded from 16 bar back to ambient pressure. The compression work is around 20 MW and the expansion work around 16 MW, hence the losses are in the region of 4 MW for this example. The hot air expander 28 can be sized to match the mass flow being bled or it could have a different capacity to allow some optimization to be carried out between storing the air and having greater or lesser capacity at certain periods. For example the hot air expander could have a capacity of 100 kg/s and 33 MW. In normal bleed operation the flow through the expander is 50 Kg/s and then at peak periods this can be increased to 100 kg/s with supplemental air from the compressed air storage. It may also be preferable to insert a flow control valve upstream of the hot air expander to regulate the flow into this machine or to use some form of variable geometry to allow mass flow to be varied in a controlled manner.

In FIG. 8a, the power output is 219 MW for the GT+16 MW for the hot air expander 28. To switch rapidly from mode 8a) to mode 8b) involves partially closing the IGV's while at the same time injecting 100 kg/s from the compressed air system such that the flow from the gas turbine to the hot air expander is reversed and the air flow to the hot air expander is provided by the compressed air system rather than the GT. It can be seen that 50 kg/s is being injected into the gas turbine and a similar amount provided to the hot air expander. The change in power output between these two modes of operation is around 40 MW, so the hot air expander increases the range of power increase by a further 20 MW. As in previous examples, the same amount of air is passing through the combustor in FIG. 8a as in FIG. 8b, and the temperature post compression is 406° C. and the pressure is 16 bar, also the same. Furthermore, the hot air expander also sees the same mass flow, temperature and pressure conditions. The important point is that the design allows the injected air to both replace the air being bled from the gas turbine and to inject additional air into the gas turbine.

FIG. 8c shows the system of FIG. 8b once it has fully re-opened the IGV's. This is a slower process than the switch between modes 8a and 8b, but provides a further power increase of 34 MW in addition to the rapid 40 MW change. The advantage of this method is that it is possible to increase the amount of rapid power increase above that shown in FIGS. 3-7. Furthermore, much of the normal power increment is still available to add after the rapid increase. Finally, it should be noted that the total power output of the gas turbine has been also increased as the hot air expander adds an additional 17 MW to the total power output of the plant.

FIG. 8d shows the same plant in a mode where the TES 14 and the compressed air store 16 are being recharged at a rate of 50 kg/s. In this mode the TES is at the same pressure as the gas turbine and the hot air expander is not in use. The system is likely to be treated as not being in a fast response mode as there is no pressure difference between the TES and the gas turbine that would allow for rapid injection to occur. This mode is likely to be used during periods when rapid power increases are not offered to the grid as a service.

In the FIGS. 8a to 8b step, the additional hot gas expander functionality is combined with switching the GT from operating in a bleed mode to operating in an injection mode, which increases the extent of the power modulation (in this case—an increase). The CAES system itself switches from being inactive (storage mode) to being in a discharge mode. In FIG. 8a the IGV's start fully open.

FIGS. 8e and 8f show an alternative arrangement where the hot air expander 28 is connected separately to the gas turbine by an alternative flow path comprising its own separate respective passageway 32 in fluid communication with one or more fluid connections of the GT. In FIG. 8e, the GT output is the same as in FIG. 8a, and 50 kg/s is being bled and vented whilst the CAES is inactive. However, on re-injection in FIG. 8f (corresponding to FIG. 8b) the injected mass flow entering the gas turbine is higher although the figures for the overall mass flow through the turbine are not changed as the same bleed rate to the hot air expander continues.

In the FIGS. 8e to 8f step, the additional hot gas expander functionality is combined with switching the GT from operating in a bleed mode to operating in a dual mode where the GT continues to bleed from one or more fluid connections whilst gas is also now injected, which again effectively increases the extent of the power modulation (in this case—an increase). The CAES system again switches from being inactive (storage mode) to being in a discharge mode. In FIG. 8e, the IGV's again start fully open. In FIG. 8f, it is highly desirable that injection and extraction occur at suitable (e.g. separate) locations to the GT where the effect of injection and extraction do not create any undesirable distortions to the flow within the GT or around the combustors.

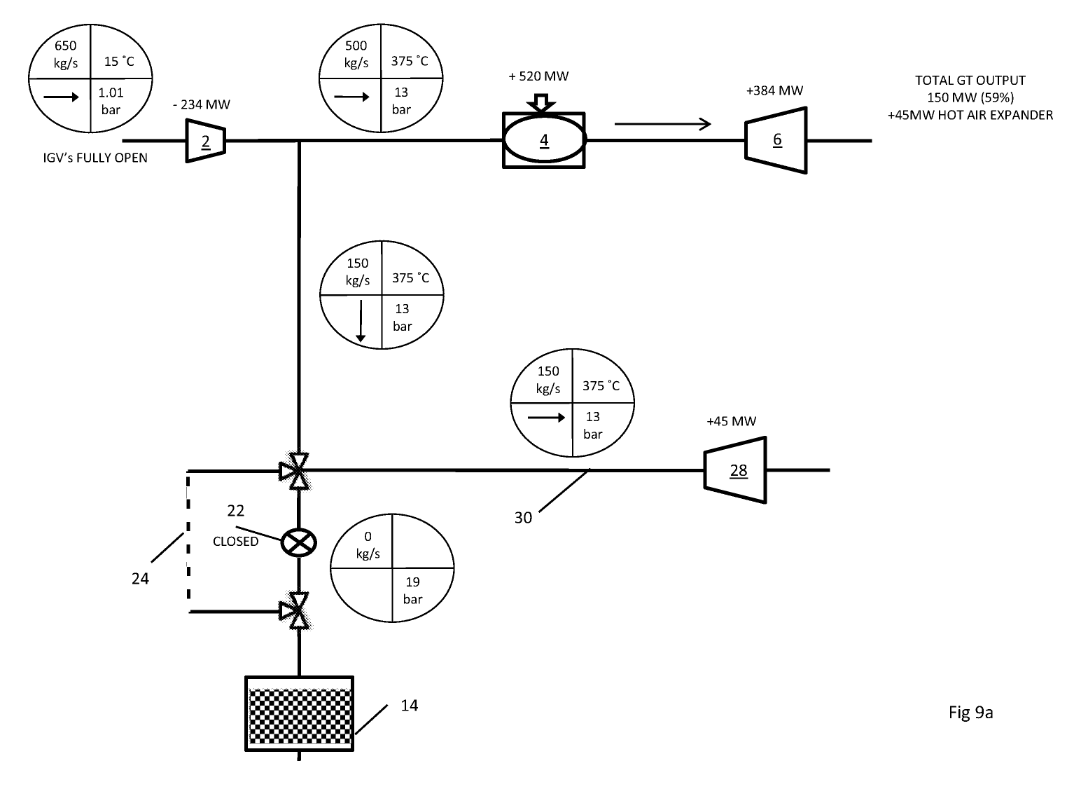

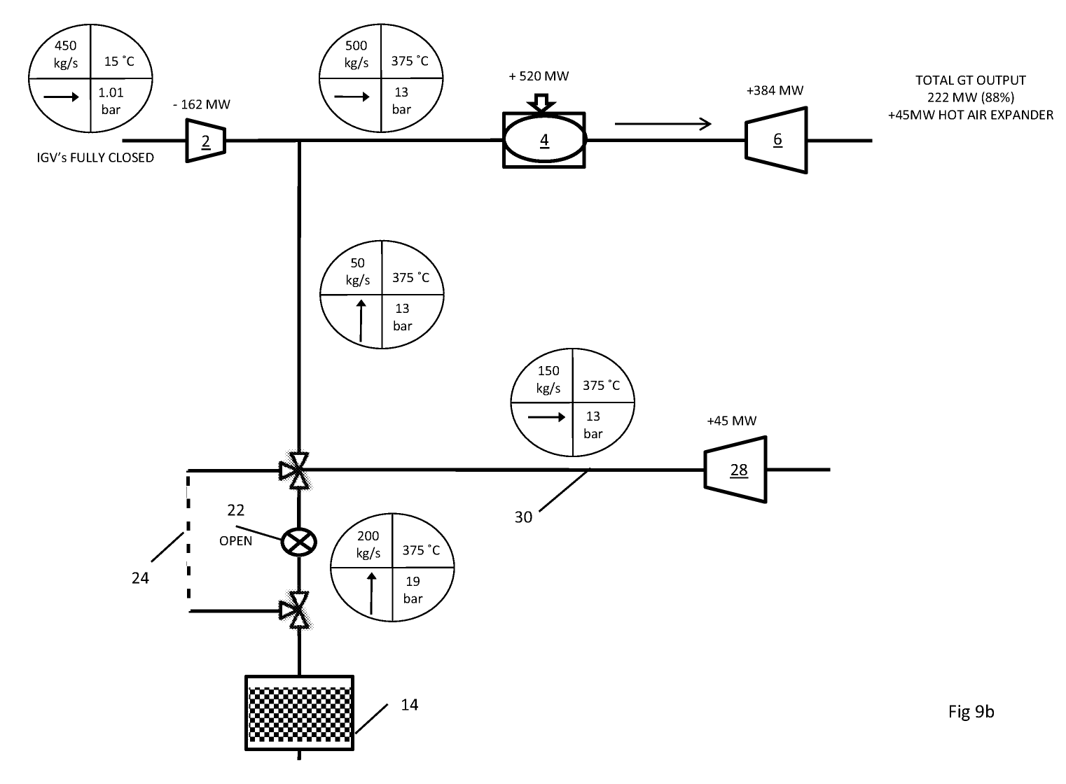

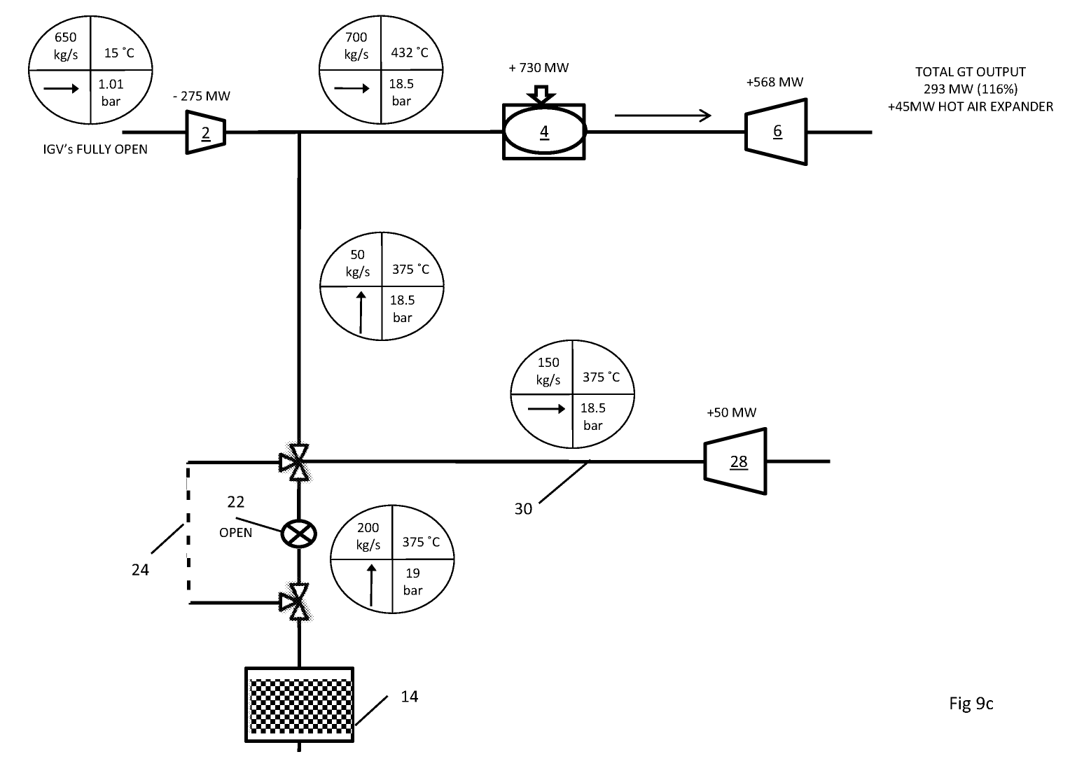

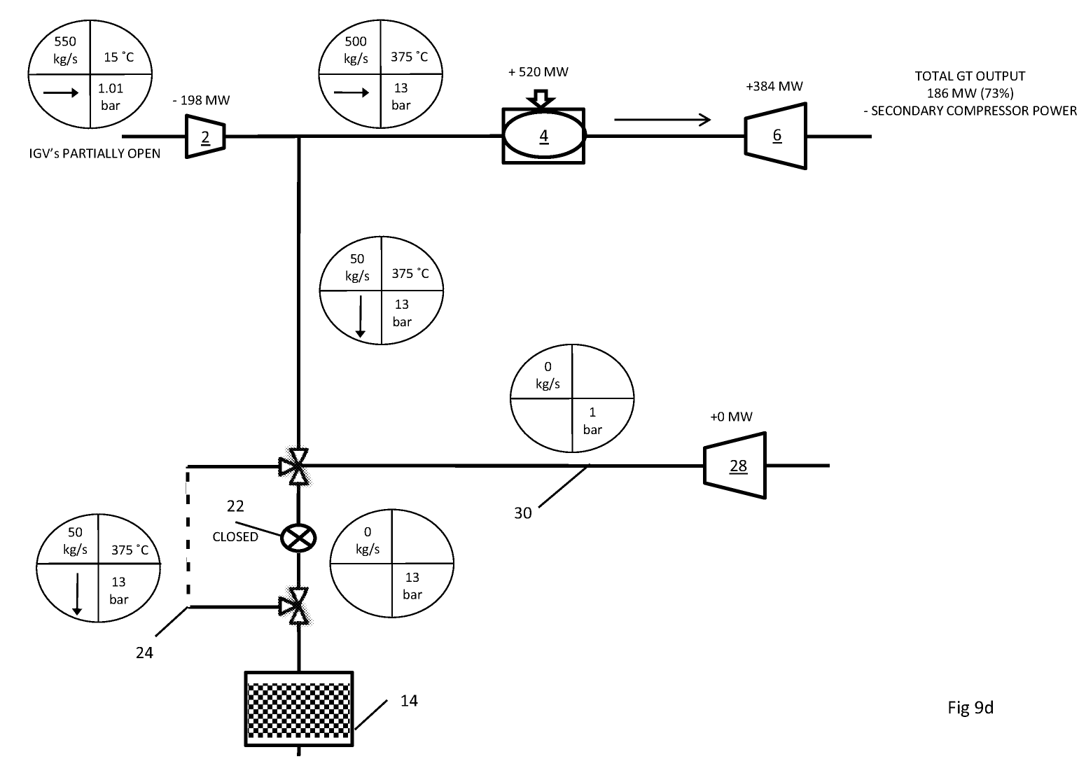

FIGS. 9a to 9d broadly follow the same principles as FIGS. 8a to 8d, but extend them to achieve an even higher amount of increased power due to (i) the use of a higher power hot gas expander and (ii) fully utilising the IGV functionality by varying the mass flow through the compressor from 650 kg/s (IGV's fully open) to 450 kg/s (IGV's fully closed). Thus, a power modulation step/switch from FIGS. 9a to 9b is a very fast response because it again keeps operating conditions the same in both turbines, whilst a further power modulation step/switch (in the same direction i.e. increase) from FIGS. 9b to 9c is a slower type response because operating conditions need to change in both expanders, whilst FIG. 9d again illustrates a charge mode for the CAES.

Thus, referring to FIG. 9a, the gas turbine is operating with IGV's (fully) open and 150 kg/s being bled from the gas turbine through the hot gas expander (CAES store inactive). Consequently around 500 kg/s is passing through the combustor and the temperature post compression is 375° C. and the pressure is 13 bar. The losses associated with the compression and re-expansion are in the region of 11 MW and the hot air expander is producing around 45 MW of power. The gas turbine power output is around 75% of full load capacity when the 45 W is included.

In FIG. 9b the gas turbine has now switched to a higher power mode by fully closing the IGV's so as significantly reduce the mass flow through the compressor to 450 kg/s whilst also reversing the air bleed from 150 kg/s out to 50 kg/s injection into the gas turbine. At the same time the 150 kg/s flow to the hot air expander is also maintained by the air flow that is now air discharging from the air store. As has previously been shown, the temperatures and pressures within the GT system should all broadly stay constant if the mass flows are varied so that the flow through the combustor stays broadly constant, and likewise for the additional hot gas expander (or expander/combustor if used). The reduction in compressor work of the gas turbine is in the region of 72 MW between the FIG. 9a and FIG. 9b power generation modes, and hence it is possible to increase the power output of the gas turbine by 72 MW in a matter of a few seconds. This could potentially occur over one second assuming suitable valves and controls were used.

FIG. 9c shows the gas turbine having been transitioned from the mode in FIG. 9b to a full power mode. This is likely to take a longer period of time as there will be thermal stresses involved from switching from 13 bar 375° C. post compression conditions to 18.5 bar and ˜440° C. post compression conditions. In addition the hot air expander also adds around a further 50 MW to the total power plant output.

FIG. 9d shows the same plant in a mode where the TES and the compressed air store are being recharged at a rate of 50 kg/s. In this mode the TES is at the same pressure as the gas turbine and the hot air expander is not in use. The system is likely to be treated as not being in a very fast response mode (i.e. Improved Frequency Response mode) as there is no pressure difference between the TES and the gas turbine that would allow for rapid injection to occur. This mode is likely to be used during periods when rapid power increases are not offered to the grid as a service.

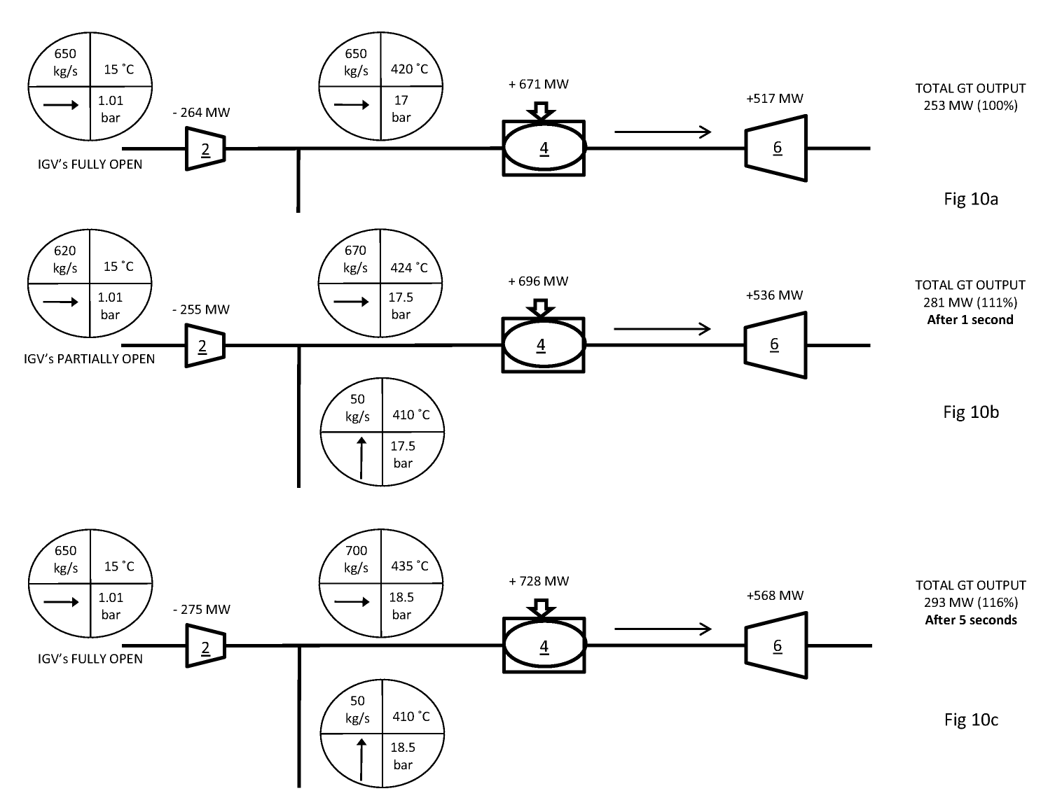

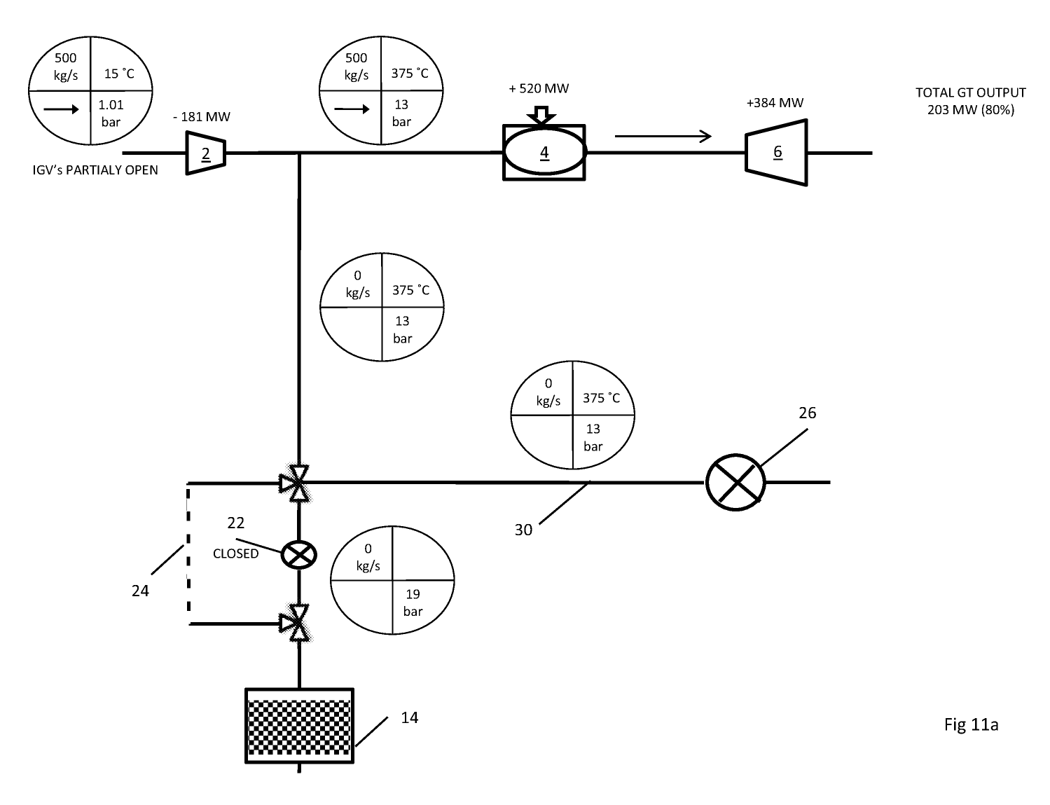

According to the invention, to obtain an Improved Frequency response of merely a few seconds, the mass flow rate through the GT, and hence the combustor and turbine operating conditions, should be proactively controlled such that there is either no change, or, only a minimal change in GT mass flow rate during the time period of the power modulation. This is achieved by selectively changing the compressor mass flow rate and by proactively partially or fully balancing the GT mass flow rate using a compensatory mass flow rate from a compressed air system. While the examples of FIGS. 4-9 achieve this by fully balancing the mass flow rate change caused by the IGV alteration in the compressor with an equivalent compensatory mass flow, it should be appreciated that power modulation could still be successfully achieved within a small deviation from this ideal, as illustrated in FIGS. 10a to 10c below. In particular, while the mass flow through the combustor and turbine should be kept broadly constant, a less than 6% change in combustor mass flow per second is likely to be acceptable (dependant upon the GT), more preferably a less than 4% change in combustor mass flow per second, and ideally less than 2% change in combustor mass flow per second.

FIGS. 10a to 10c illustrate this with a similar hybrid system to that shown in FIGS. 4a to 4c, however the difference is that the mass flow through the combustor and turbine is allowed to increase in the first second by 3% (a change in mass flow rate of 20 kg/s through the combustor/turbine) while the IGV's are not closed as far and 50 kg/s is still injected (as in FIG. 4b). Hence, the selected alteration in how much air is transferred, as a compensatory mass flow, between the CAES system and the GT system via the one or more fluid connections slightly exceeds the selected change in mass flow rate of the air through the compressor achieved by selectively altering its configuration. In this way, it is possible to increase power in the first second to 111% of output and then further to 116% of output within 5 seconds.

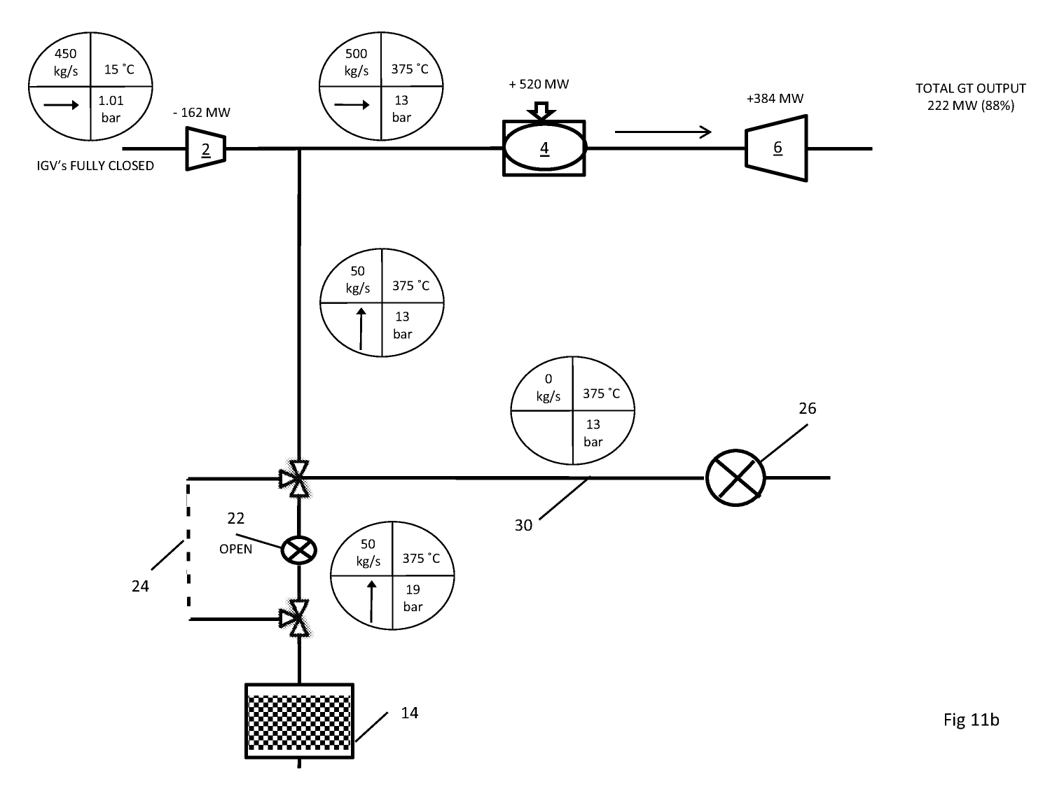

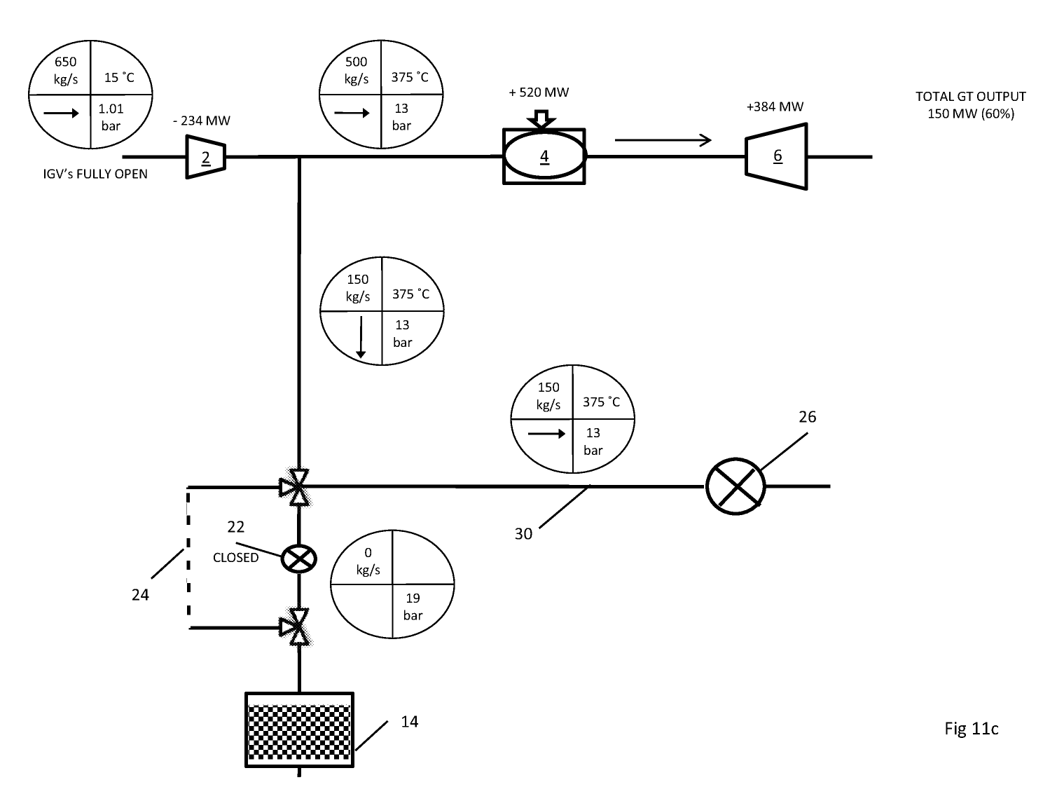

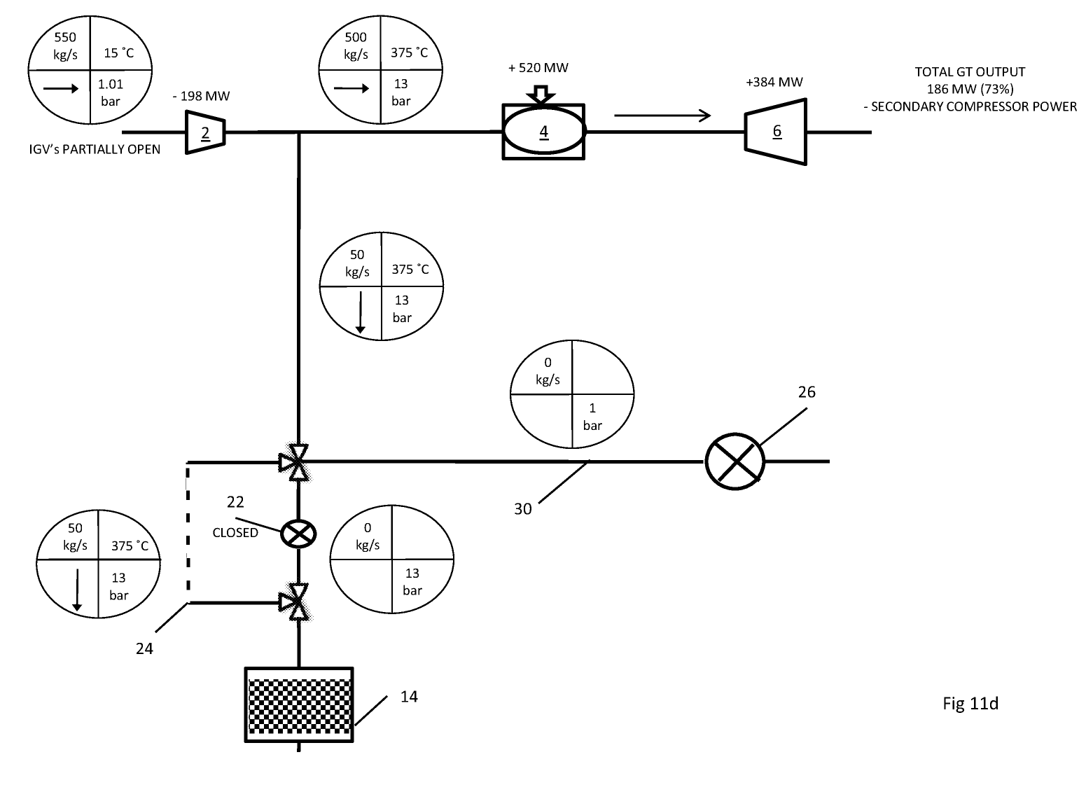

FIGS. 11a to 11d show the same GT system, but modified again (as in FIG. 7d) to include ancillary depressurisation apparatus in the form of a fast-acting vent valve 26 to achieve rapid bleed rates by venting to atmosphere. The vent valve 26 could again be in its own independent respective passageway connected to the GT, or via a passageway shared with the CAES network. Throttling to atmosphere is particularly useful when turning power down rapidly, and can extend the turndown over the hot air expander solution described above as it generates no power, but obviously for that reason is usually too inefficient except as a transient mode.

FIG. 11a depicts the GT system operating in an Initial Mode at a lower power setting of ˜80% (similar to the example of FIG. 6a), while FIGS. 11b-d depict three alternative “Balanced Modes” that the system is capable of very rapidly switching to without overly disturbing the gas turbine conditions, by selectively adjusting the IGV's and selectively adjusting the rate of air injection/bleed to provide a compensatory mass flow to ensure a near constant (e.g. balanced) mass flow through the combustor. Thus, from the initial power output in FIG. 11a, the power can be rapidly increased by fully closing the IGV's to 222 MW i.e. ˜88% in FIG. 11b (similar to FIG. 6c) and by starting an injection mode (e.g. from storage) to balance GT mass flow rate. Alternatively from the FIG. 11a Initial Mode, the power output can be rapidly reduced by appropriate IGV adjustment of compressor power either to an overall output of 186 MW i.e. ˜73% (similar to FIG. 6b), and by starting a small bleed mode to storage drawn by a second stage compressor (not shown) which balances the GT mass flow rate, or, alternatively, more significantly turning down to 150 MW i.e. ˜60% by starting a significant bleed mode through fast-acting vent vale 26 to atmosphere which also balances the GT mass flow rate. It will be appreciated that an Initial Mode where the CAES system (and any thermal energy storage system present) is inactive can run for a long period without reaching any limit due to the storage capacity. However, it may be advantageous in some instances for an Initial Mode (i.e. held in readiness for a very rapid power modulation) to include a small (e.g. minimal) bleed to storage (as in FIG. 11d), or a small (e.g. minimal) injection from storage (as in FIG. 11d), for example, to improve responsiveness.

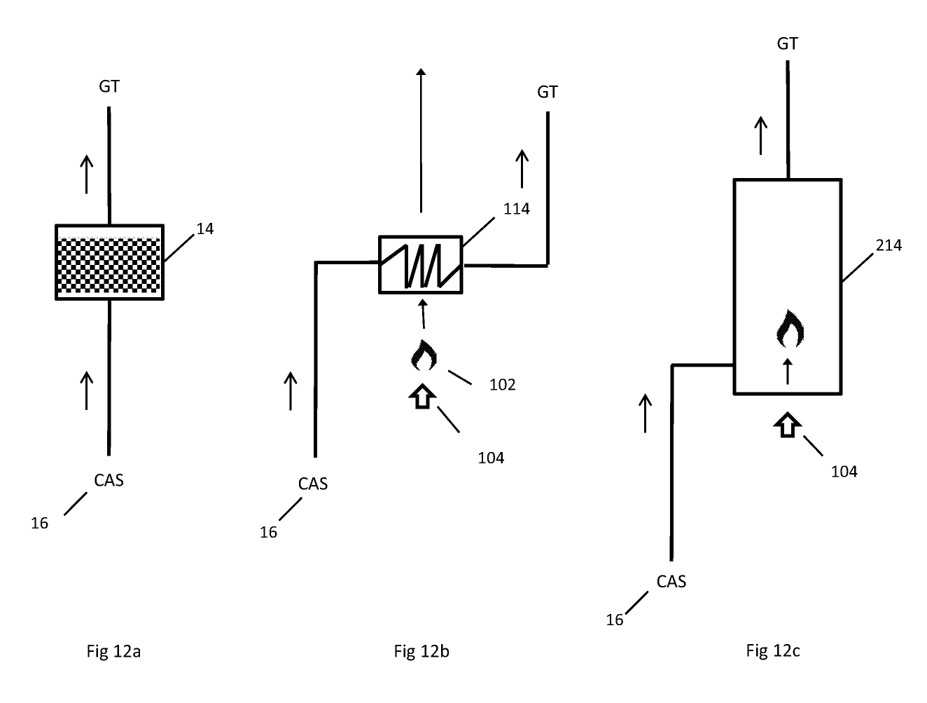

Turning now to FIGS. 12a-c, 13 and 14, these illustrate modifications that may be made to the hybrid systems described in the Figures above.

In the above Figures, a direct TES 14 is proposed for storing and returning heat because such stores transfer heat more efficiently and hold the heat in readiness such that it can be returned without delay. However, an indirect TES may also be used (e.g. a heat exchanger coupled to liquid stores which do not need for example to store the heat at high pressures) within the hybrid system, although it may not be able to provide a rapid response injection mode unless steps are taken to keep it up to temperature.

In the case of either an indirect TES or direct TES, it may be advantageous for the ACAES system to include a gas buffer storing gas (preferably that has not yet been heated by the TES), and linked to the TES, so that when rapid power modulation is required gas is instantly available.

Usually, the GT system will be integrated with an adiabatic compressed air energy storage (ACAES) system in which the heat of compression is stored and returned. However, other CAES systems are not excluded.

FIGS. 12a to 12c are schematic diagrams showing alternative systems for heating air during an injection mode. FIG. 12a illustrates the use of a direct TES 14 interposed in the network between the compressed air store 16 and GT system, as in earlier figures. FIGS. 12b and 12c, by contrast, depict alternative heater systems that may be used and which do not return stored heat.

FIG. 12c shows a direct combustor 214 interposed in the network between the compressed air store 16 and GT system. A direct combustor will use less fuel 104 than an indirect combustor as combustion occurs within combustion chamber 214 disposed within the flow passageway network, with the exhaust gases conveniently passing downstream into the GT. Such a direct fired additional combustor may easily be kept in readiness to respond to a rapid power modulation requirement. For example, a small flame may be kept running continuously, the air within (the pressurised chamber) kept at a required temperature and pressure, for example, with a small bleed from the compressed air store or from a small ancillary compressor to provide sufficient oxygen to maintain the flame. It should also be able to meet the change in mass flow, for example, having a fast responding fuel valve and suitable burner capacity. Unlike any heat exchanger based system, if it is maintained at temperature by the small flame (mentioned above) then it will not experience thermal cycling induced stresses or temperature variations upon power modulation.

Alternatively, FIG. 12b shows a heat exchanger 114 disposed within the flow passageway network and indirectly heated by a flame 102 from combustion of fuel (e.g. fossil fuel) 104. This arrangement requires an exhaust chimney for the exhaust gases. Such an arrangement is less efficient than a direct combustor and may be more difficult to keep in readiness (e.g. a small amount of combustion may be required at all times). Moreover, thermal expansion issues, and issues with the establishment of thermal gradients when brought into operation would require careful management.

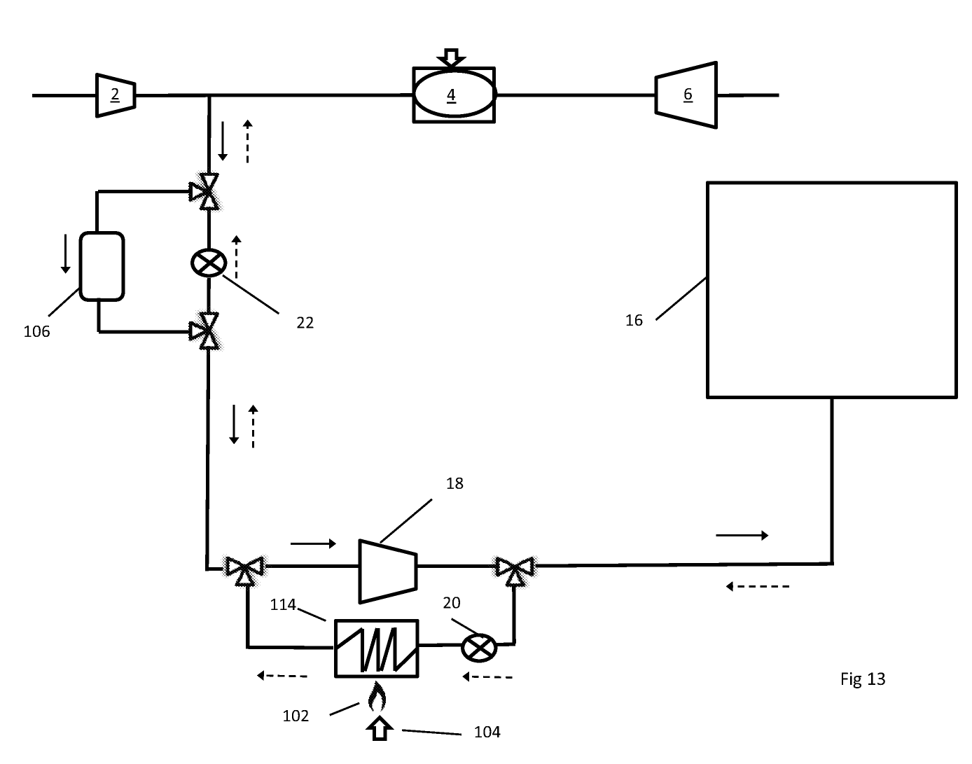

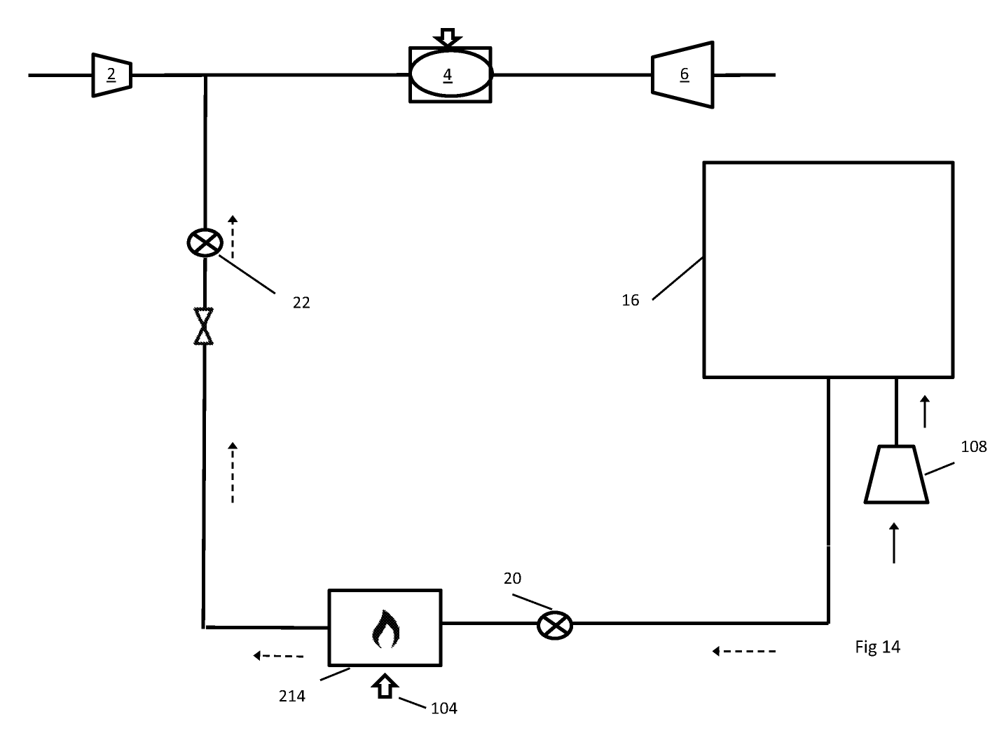

Such alternative heater systems may be provided in the airflow passageway network instead of a TES, or, in addition to the latter, in which case it may be provided in series or in an alternative (e.g. parallel) passageway, for example, to provide additional heat (for additional mass flow), or provide heat at a faster rate, or provide heat at a different temperature. A heater system may be configured such that the air returning from storage can be heated to a desired temperature having regard to the GT system conditions (e.g. to match them or exceed them by a selected amount), whereas a TES will only return heat at roughly the same temperature that it was charged. FIGS. 13 and 14 show examples of hybrid CAES systems based on alternative heater systems.

Turning to FIG. 13, this hybrid system, as in earlier figures, uses the GT system to charge the air store 16. The charge and discharge pathways in the network are shown as solid and dotted arrows, respectively. Air bled from the GT system passes through a heat extraction system 106, such as a cooling heat exchanger (disposed in a parallel pathway to (closed) fast-acting pressure reducing valve 22), where the heat of compression is removed and discarded. The air then passes downstream through second stage power machinery comprising an intercooled compressor 18 which raises it to the pressure in the compressed air store 16. Upon discharging therefrom, returning air passes successively through a pressure reducing valve 20 (where it is isenthalpically expanded) and an indirect combustor 114, both disposed in a parallel pathway to the intercooled compressor 18. The air is heated by the indirect combustor to a suitable selected temperature (e.g. matching the GT conditions), before passing through the second pressure reducing valve 22 and entering the GT system. This system avoids the need for a pressurised thermal energy store and the necessity to keep it charged at the correct temperature.

FIG. 14 illustrates a GT system integrated with a more basic compressed air system where the GT system is not used to charge the compressed air store.

The system as depicted has minimal equipment and hence would be a simpler refit to an existing GT system. To that end, a small (e.g. ambient air fed) intercooled compressor 108, or series of compressor stages, is provided to charge a compressed air store such as a pipe store at a small mass flow rate, where the hybrid system is only required to provide (e.g. rapid) power modulation from storage on relatively rare occasions, such that recharging can be accomplished slowly using small power machinery. When a rapid response is required, pressure reducing valve 20 acts to let compressed air out of the store at a suitable flow rate. It the passes through direct combustor 214 which heats it to a suitable selected temperature (e.g. matching the GT conditions), before pressure reducing valve 22, with finer mass flow rate control, allows it to enter the GT system across a pressure drop at a desired flow rate.

Note to allow direct combustor 214 to be operational it may be necessary to have a small feed of air through both valve 20 and 22 as previously explained.

The system as shown is unable to extract air from the GT system, and hence, its functionality in terms of providing a fast response is correspondingly limited to providing for increasing air injection only. However, a further modification could allow this if, for example, a hot gas expander arrangement as in FIGS. 8e and 8f were to be provided.

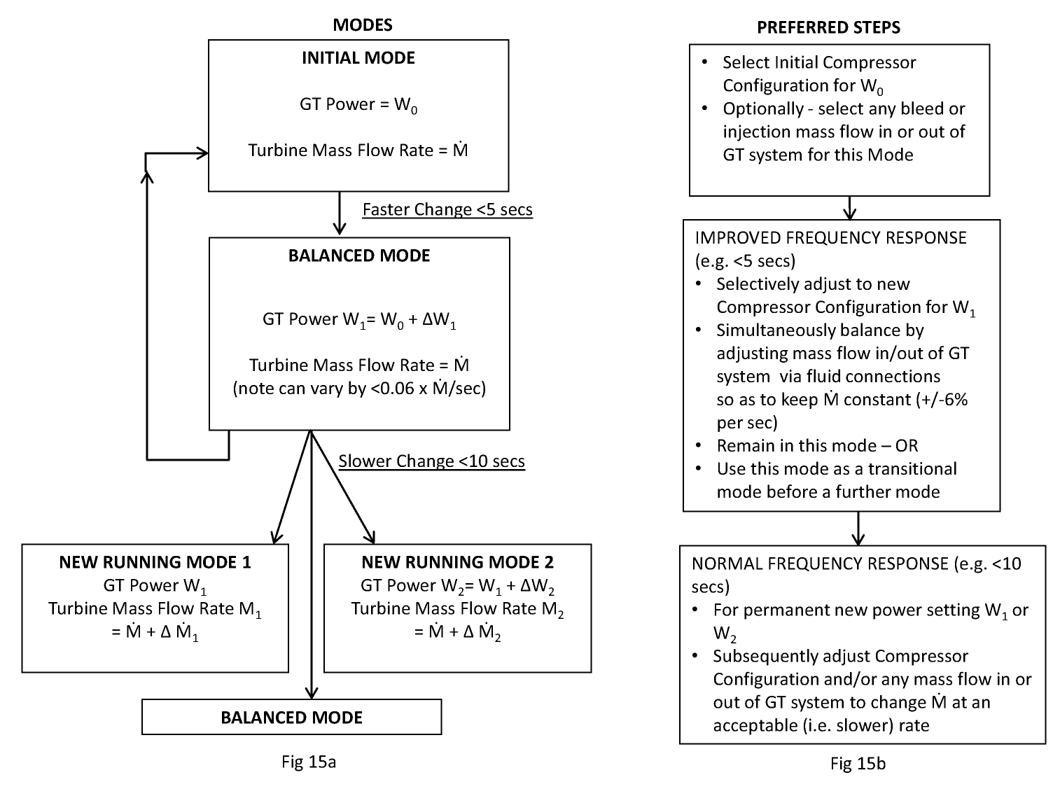

Lastly, FIGS. 15a and 15b are flow logic diagram that respectively illustrate, by way of example, possible modes that the hybrid system may switch between, as exemplified above, and associated preferred steps to achieve this.

Thus, the system may operate in an initial power generation mode “Initial Mode” where it is ready to provide an Improved Frequency Response in 5 seconds or less and the turbine mass flow rate is M and GT power is W₀. This may involve selecting a suitable initial compressor configuration (for example, ensuring the IGV's have the capacity to be altered by the expected amount needed for a desired change of power ΔW₁), and optionally, any bleed or injection mass flow rate in or out of the GT system for this mode. The bleed mode may be a bleed to the compressed air store and/or a bleed to air depressurisation apparatus that extracts useful work, for example, a hot gas expander or combined combustor and expander (optionally with downstream apparatus to extract further power), or to depressurisation apparatus that does not extract useful work such as a vent valve.

When an Improved Frequency Response is required, a control system (with associated sensors) selectively adjusts the compressor to a new Compressor Configuration for a new power setting W₁ (=W₀+ΔW₁) for a second power generation mode or “Balanced Mode”, so-named because simultaneously, the anticipated change in mass flow rate through the compressor is balanced by the control system adjusting the mass flow being transferred in or out of the GT system via the fluid connections so as to keep M roughly constant in the combustor and turbine, within the limits that it may change by up to +/−6%×M per sec.

From FIG. 15a, it may be seen that the system may then remain for some time in the Balanced Mode if that is sustainable and convenient.

More usually, the Balanced Mode will not be an ideal long term running mode, and that mode will only be used as a transient mode (e.g. held for may be no more than 10 seconds, or up to 30 seconds, or up to a minute). Hence, the system may then revert back to the Initial Mode in readiness for another Improved Frequency response

Alternatively, it may switch from the Balanced Mode to a new (e.g. more efficient or sustainable) Running Mode 1 that has the same power W₁, but this is now achieved by alteration, in a slower paced (Normal Frequency Response e.g. taking up to 10 seconds) change, to a new mass flow rate M₁ through the combustor and turbine usually by resetting the compressor configuration; FIG. 7c is an example of a new Running Mode 1. A further option from the Balanced Mode is a switch to a new Running Mode 2 that has a different power W₂, usually a further power increase over an initial power increase achieved by the Balanced Mode (or, less commonly, a further decrease over an initial decrease), again achieved in a slower paced (Normal Frequency Response e.g. taking up to 10 seconds) change resulting in a new mass flow rate M₂ through the combustor and turbine; FIG. 4c is an example of a new Running Mode 2.

Larger power modulations may require a switch from the GT system operating in a bleed mode to an injection mode (or vice versa), and may be needed to match or nearly compensate for an IGV alteration from at or near fully open to at or near fully closed. While the present invention relates to the operation of a hybrid power generation system comprising a compressed air system, it should be appreciated that some bleed modes need not necessarily involve the compressed air store. For example, FIGS. 8a and 9a are examples where power is modulated from an “Initial Mode” where the GT system is bleeding via a separate hot gas expander to atmosphere while in readiness for a fast response, but the air store is inactive, and then undertakes that response to adopt a “Balanced Mode” involving injection of air from the air store. Preferably, where any bleeding to depressurisation apparatus is occurring before a rapid power modulation involving injection from the air store, it is preferably if the depressurisation apparatus is fluidly connected to the one or more flow connections by the same passageway so that its supply is not disrupted by a change of the CAES store from inactive to discharging and the changes in flow in the GT are minimised.

For the avoidance of doubt, the present invention relates to the operation of a hybrid power generation system based upon a conventional gas turbine design in which the compressor and turbine are always (mechanistically) coupled and fluidly connected downstream of one another. This is in contrast to prior art proposed gas turbine designs in which the compressor and turbine can be coupled together and decoupled at will and where flow connectors (e.g. with multi-direction valves) are required to allow or prevent air flow passing successively downstream from the compressor to the combustor and turbine.

Furthermore, whilst a hybrid system based on an ACAES system that stores and returns heat, and that comprises only power machinery that extracts useful work, may be the most efficient storage/generating solution, the present invention is more focussed upon providing a hybrid GT system that can respond in a matter of seconds to a grid requirement. Hence, it encompasses broader system arrangements as detailed above, with alternative components or sub-systems. (For example, power machinery either provided as a second stage in a CAES, or as ancillary depressurisation apparatus, are constrained by the flow rates they can handle and (slower cold start-up), whilst direct and indirect TES systems may be less flexible or responsive than heater systems.)

1. A method of modulating the power output of a hybrid combustion turbine power generation system (CTPGS) that includes a combustion turbine (GT) system comprising a compressor, a combustor and a turbine fluidly connected downstream of each other; and a compressed air energy storage (CAES) system integrated with the GT system via one or more fluid connections to the GT system so as to allow air to be extracted from, or injected into, the GT system, the CAES system including an airflow passageway network and associated valve structure leading from the one or more fluid connections to a compressed air store, the method comprising:
modulating the power output whilst air is passing respectively downstream through the compressor, combustor and turbine by increasing or decreasing the power output by, respectively,
selectively reducing or increasing the mass flow rate of the air through the compressor by altering its configuration, and
simultaneously selectively adjusting how much air to transfer as a compensatory mass flow between the CAES system and the GT system via the one or more fluid connections, in order partially or fully to compensate for the reduction or increase in mass flow rate through the compressor, thereby minimizing or preventing any change in mass flow rate through the combustor and turbine at least for a selected time period.

2. The method according to claim 1, wherein the CAES system is integrated with the GT system such that it charges and discharges via the GT system, air being both extracted from it, and injected into it, via the one or more fluid connections.

3. The method according to claim 2, wherein the airflow passageway network comprises a first thermal energy store (TES) that removes and returns thermal energy to the compressed air upon charging and discharging the air store, disposed between the latter and the one or more fluid connections.

4. The method according to claim 3, wherein the first TES is a direct TES.

5. The method according to claim 1, wherein the compensatory mass flow ensures that the rate of change of mass flow rate within the combustor and turbine does not exceed 6% per second for the selected time period.

6. The method according to claim 1, wherein the compensatory mass flow ensures that the mass flow rate through the combustor and turbine remains substantially unchanged for the selected time period.

7. The method according to claim 1, wherein the power output is modulated from an initial power output to a second power output within a response time of 5 seconds or less.

8. The method according to claim 1, wherein the CAES system is operating before the power modulation in a mode in which it maintains air for injection into the one or more fluid connections at a pressure upstream thereof of at least 0.5 bar higher than the gas turbine operating pressure.

9. The method according to claim 1, wherein the CAES system comprises at least one flow regulating device to regulate the mass flow rate of air being injected into, or extracted from the one or more fluid connections, optionally positioned between any TES or heater system that is present in the network, and the one or more fluid connections.

10. The method according to claim 1, wherein the compensatory mass flow between the CAES system and the GT system is provided via one or more fluid connections provided in ancillary passageways of the GT system containing airflow that bypasses the combustor.

11. The method according to claim 1, wherein the configuration of the compressor is altered by altering the angle of variable inlet guide vanes.

12. The method according to claim 1, wherein the CAES system further comprises air depressurization apparatus in fluid communication with the one or more fluid connections for pressurizing compressed air extracted from the GT system, the air depressurization apparatus optionally being selected from a hot air expander or combined combustor/turbine that extracts useful work, or from a depressurization apparatus that does not extract useful work.

13. (canceled)

14. (canceled)

15. The method according to claim 12, wherein the air depressurization apparatus is connected by its own separate respective airflow passageways to the one or more fluid connections.

16. The method according to claim 1, wherein the hybrid system comprises a controller and associated sensors to (i) alter the configuration of the compressor in order to obtain a desired modulation of the power output, and to (ii) selectively adjust how much air to transfer as a compensatory mass flow between the CAES system and the GT system.

17. The method according to claim 1, wherein the compensatory mass flow is provided for a selected time period of no more than 20 seconds, before the GT system alters to a different power generation mode.

18. The method according to claim 1, wherein at least one further stage of power machinery is provided between the GT system and the air store, and optionally wherein the at least one further stage of power machinery and a pressure reducing device are provided in alternative passageways between the GT system and the air store.

19. (canceled)

20. The method according to claim 1, wherein the airflow passageway network comprises a heater system that transfers thermal energy to compressed air that is discharging from the air store, the heater system optionally being selected from a direct combustor or a heat exchanger.

21. (canceled)

22. (canceled)

23. The method according to claim 20, wherein the GT system is also configured to charge the air store and the airflow passageway network further comprises a cooling system that removes thermal energy from compressed air being extracted from the GT system.

24. The method according to claim 20, wherein power machinery other than the GT system is provided to charge the air store with compressed air, either via the airflow passageway network or a separate airflow passageway network.

25. (canceled)

26. A hybrid combustion turbine power generation system (CTPGS), comprising:
a combustion turbine (GT) system that includes a compressor, a combustor and a turbine fluidly connected downstream of each other;
a compressed air energy storage (CAES) system integrated with the GT system via one or more fluid connections to the GT system so as to allow air to be extracted from, or injected into, the GT system, the CAES system including an airflow passageway network and associated valve structure leading from the one or more fluid connections to a compressed air store; and
a controller and associated sensors to (i) alter the configuration of the compressor in order to obtain a desired modulation of the power output, and to simultaneously (ii) selectively adjust how much air to transfer as a compensatory mass flow between the CAES system and the GT system, via the one or more fluid connections, in order partially or fully to compensate for the reduction or increase in mass flow rate through the compressor.
